(19) United States
(12) Patent Application Publication
(10) Pub. No.: US 2007/0150208 A1
(43) Pub. Date: Jun. 28, 2007

(54) Method, apparatus and article to facilitate analysis of multi-dimensional structures, for example proteins or polymers

(75) Inventor: Thomas Gregory Dewey, Claremont, CA (US)

Correspondence Address: SEED INTELLECTUAL PROPERTY LAW GROUP PLLC, 701 FIFTH AVE, SUITE 5400, SEATTLE, WA, 98104, US

(73) Assignee: KECK GRADUATE INSTITUTE, Claremont, CA (US)

(21) Appl. No.: 11/549,095

(22) Filed: Oct. 12, 2006

Related U.S. Application Data
(60) Provisional application No. 60/726,829, filed on Oct. 14, 2005.

(51) Int. Cl. G01N 31/00

(52) U.S. Cl. 702/27; 702/1

(57) ABSTRACT

A symbology or mapping between multi-dimensional topographical parameters and characters allows multi-dimensional topographical problems to be turned into one-dimensional sequence problems, allowing fast, computationally efficient and robust sequence analysis methodologies to be employed. Substitution matrices allow the scoring of matches or hits. Such techniques may be applied to proteins, polymers or other multi-dimensional structures.

### CROSS-REFERENCE TO RELATED APPLICATION

This application claims benefit under 35 U.S.C. 119(e) of U.S. provisional patent application Ser. No. 60/726,829, filed Oct. 14, 2005.

### STATEMENT OF GOVERNMENT INTEREST

This invention was made with government support under Grant No.1P01GM 63208, awarded by the National Institutes of Health. The government has certain rights in this invention.

### BACKGROUND OF THE INVENTION

1. Field of the Invention

This disclosure generally relates to analysis of multi-dimensional structures, for example analysis of the three-dimensional topologies of proteins, polymers or other structures.

2. Description of the Related Art

There are a number of ongoing federally funded projects focused on structural genomics. As a result of these efforts, the number of known protein structures continues to grow. Consequently, structure comparison techniques have become an increasingly crucial bioinformatics tool. Because protein structures evolve more slowly than protein sequences, structure comparison can be used to assess distant evolutionary relationships and common functions for pairs that do not have high sequence similarity. Uncovering such distant relationships between proteins can inform drug discovery. Structure alignment is also a central tool for protein classification and structural genomic initiatives.

Currently, no computationally efficient approaches exist for performing protein structure database searching and for performing multiple protein structure alignment. This represents a real computational problem for structural genomic initiatives. Protein classification schemes inform homology modeling and allow protein structures to be predicted from sequences, a long standing problem in the field.

Despite the importance of structure comparison, a number of fundamental issues remain unresolved. One of the central problems is the mathematically difficult problem of scoring and optimizing the structural similarity of 3-dimensional objects. Most protein comparison algorithms treat proteins as rigid bodies and measure the quality of the superposition using distance-based measures such as root mean square distance (RMSD). Even after considerable effort, no algorithm has emerged as the alignment method of choice. Distance-based measures suffer from a more fundamental problem in that they do not obey the triangle inequality. That is: similarity between proteins 1 and 2 and proteins 1 and 3, do not imply similarity between protein 2 and 3. This issue is particularly prominent in proteins composed of distinct separate domains.

In light of the failings of distance-based metrics to adequately address the problem, new methods, structures and articles for facilitating the analysis of multi-dimensional structures, for example the three-dimensional structures of proteins, is desirable.

### BRIEF SUMMARY OF THE INVENTION

Methods, apparatus and articles are taught herein that employ encoding of multi-dimensional structures, for example protein topologies, into a topological alphabet. The encoding transforms a topological structure alignment problem into a sequence alignment problem. This allows well-established, and computationally efficient, sequence alignment algorithms to be advantageously employed. The encoding may be based on parameters derived from knot theory, for example writhing numbers, and may use such parameters to develop protein structure classification schemes.

In one embodiment, a method of mapping between multi-dimensional topological information and one-dimensional sequence representation, useful in analyzing structures, includes for each of a number of substructures, determining a non-distance parameter indicative of a topology of the substructure; and determining a sequence of character representations for each of at least two of the substructures, the respective character representation for each of the substructures based on the respective determined non-distance parameter indicative of the topology of the substructure. Determining a non-distance parameter indicative of a topology of the substructure may include determining a one-dimensional value indicative of the three-dimensional topology, for example a writhing number indicative of a three-dimensional topology of the substructure comprised of the at least four alpha carbons or other repeating unit. Determining a sequence of character representations for each of at least two of the substructures may include assigning a new character representation to the determined non-distance parameters indicative of the topologies of the substructures, the character representations forming a set of character representations. Alternatively, or additionally, determining a sequence of character representations for each of at least two of the substructures may include comparing the determined non-distance parameter to at least one of a number of non-distance parameters in a library of non-distance parameters, each of the non-distance parameters in the library having a previously assigned respective character representation. The method may further include performing a sequence analysis on the determined sequence.

In another embodiment, a computer-readable medium stores instructions for causing a computer to facilitate mapping between multi-dimensional topological information and one-dimensional sequence representation, by: for each of a number of substructures, determining a non-distance parameter indicative of a topology of the substructure; and determining a sequence of character representations for each of at least two of the substructures, the respective character representation for each of the substructures based on the respective determined non-distance parameter indicative of the topology of the substructure.

In another embodiment, a method of forming a library of relationships useful in analyzing multi-dimensional topological structures composed of one or more segments using one-dimensional sequencing representations, includes for each of a plurality of structures, determining a topological parameter of at least some of a number of local segments of the structure; and for each of at least some of the determined topological parameters, determining a respective character representation based at least in part on the respective determined topological parameter. Where the structures are proteins, determining a topological parameter of at least some of the local segment may include determining a writhing number indicative of a three-dimensional topology of the local segment comprised of at least four alpha carbons or other repeating unit, for example, a writhing number of the local segment. Determining a respective character representation based at least in part on the respective determined topological parameter may include binning the determined topological parameters and assigning a character representation as a result of the binning. Binning may include grouping the determined topological parameters into a plurality of groups, each group having a range of writhing values, where the ranges of the groups are not all equal to one another. Binning may further include determining the ranges of the group based at least in part on a frequency of occurrence of the respective determined topological parameters over the number of structures. Alternatively, or additionally, binning may include determining the ranges of the group such that each group includes an approximately same number of occurrences of the respective determined topological parameters over the number of structures. The method may further include determining at least one substitution matrix for scoring alignments.

In still another embodiment, a computer-readable medium stores instructions for causing a computer to facilitate forming a library of relationships useful in analyzing multi-dimensional topological structures composed of one or more segments using one-dimensional sequencing representations, by: for each of a plurality of structures, determining a topological parameter of at least some of a number of local segments of the structure; and for each of at least some of the determined topological parameters, determining a respective character representation based at least in part on the respective determined topological parameter.

In a further embodiment, a method of analyzing protein structures includes for each of a number of local segments of a protein structure, determining a topological parameter indicative of at least one non-distance multi-dimensional characteristic of the local segment; for each of at least some of the determined topological parameters, determining a respective character representation based at least in part on the respective determined topological parameter; and forming an ordered sequence from the determined character representations. Determining a topological parameter indicative of at least one non-distance multi-dimensional characteristic of the local segment may include determining a writhing number indicative of a three-dimensional topology of the local segment comprised of at least four alpha carbons or other repeating unit. The method may further include performing a sequence analysis on the resulting ordered sequence of determined character representations. Performing sequence analysis may include determining a level of similarity between the protein structure and another protein structure. Alternatively, or additionally, performing a sequence analysis may include determining which portions of the protein structures are similar to portions of a number of other protein structures. Alternatively, or additionally, performing a sequence analysis may include searching a database of protein structures to find other protein structures similar to the protein structure.

In still a further embodiment, a computer-readable medium stores instructions for causing a computer to facilitate analysis of protein structures, by: for each of a number of local segments of a protein structure, determining a topological parameter indicative of at least one non-distance multi-dimensional characteristic of the local segment; for each of at least some of the determined topological parameters, determining a respective character representation based at least in part on the respective determined topological parameter; and forming an ordered sequence from the determined character representations.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic view showing a multi-dimensional structure in the form of a protein formed by a number of amino acids, and including at least four alpha carbons per local segment or substructure, according to an illustrated embodiment.

FIG. 1B is a schematic view showing a multi-dimensional structure in the form of a polymer formed by at least four repeating substructures, according to an illustrated embodiment.

FIG. 2 is a schematic diagram of a local segment or substructure in the form of four alpha carbons of a protein, illustrating a determination of a topographical parameter in the form of a writhing number, according to one illustrated embodiment.

FIG. 3 is a schematic diagram of an analytic environment including an analysis computing system communicatively coupled to a source of topographical information or data about a multi-dimensional structure, the analysis computing system operable to facilitate the analysis of multi-dimensional structures such as proteins, polymers or other structures, according to an illustrated embodiment.

FIG. 4 is a high level flow diagram of a method of preparing a database useful in performing analysis of multi-dimensional structures, the database including a library of structures to encode multi-dimensional topographic information into sequence information or representation, and including substitution matrices for scoring results of a sequence alignment analysis, according to an illustrated embodiment.

FIG. 5 is a mid-level flow diagram of a method of creating a library of structures, for example a library of protein topographical parameters and corresponding character representations, useful in performing the method of FIG. 4, according to an illustrated embodiment.

FIG. 6 is a low level flow diagram of a method of determining topological parameters of local segments or substructures of a multi-dimensional structure such as a protein or polymer, useful in the performing the method of FIG. 4, according to one illustrated embodiment.

FIG. 7 is a low level flow diagram of a method of determining a character representation for the local segment or substructure based on the determined topological parameters, useful in performing the method of FIG. 5, the method including binning and assigning character representations, according to one illustrated embodiment.

FIG. 8 is a low level flow diagram of a method of setting ranges for binning, useful in performing the method of FIG. 7, according to one illustrated embodiment.

FIG. 9 is a low level flow diagram of a method of grouping topographical parameters as part of binning, useful in performing the method of FIG. 7, according to one illustrated embodiment.

FIG. 10 is a high level flow diagram illustrating a method of analyzing a multi-dimensional structure such as a protein or polymer using a database including an existing library of structures, according to one illustrated embodiment.

FIG. 11 is a mid-level flow diagram illustrating a method of determining an ordered sequence, for representing a topology of a multi-dimensional structure such as a protein or polymer in one-dimension, useful in performing the method of FIG. 10, according to one illustrated embodiment.

FIG. 12 is a mid-level flow diagram illustrating a method of performing sequence analysis using an ordered sequence to determine a level of similarity between a subject structure such as a protein or polymer and another structure, useful in performing the method of FIG. 10, according to one illustrated embodiment.

FIG. 13 is a flow diagram illustrating a method of performing sequence analysis using an ordered sequence to determine portions of a subject structure such as a protein or polymer that are similar to portions of other structures, useful in performing the method of FIG. 10, according to one illustrated embodiment.

FIG. 14 is a flow diagram illustrating a method of performing sequence analysis using an ordered sequence to search a database for structures similar to a subject structure such as a protein or polymer, useful in performing the method of FIG. 10, according to one illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with wireless communications devices, wireless communications systems, for example cellular phone systems, and computing systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings provided herein are for convenience only and do not interpret the scope or meaning of the embodiments.

An approach to processing multi-dimensional topographical information is described herein. The approach generally employs encoding of multi-dimensional topographical information for a multi-dimensional structure, into a one-dimensional sequence representation via a topological symbology, mapping or “alphabet.” This approach may, for example, be useful in the field of structural genomics to encode multi-dimensional topographical information for protein structures into one-dimensional sequence representations. Alternatively, or additionally, this approach may, for example, be useful for encoding multi-dimensional topographical information about other structures, for instance polymers, into one-dimensional sequence representations.

The development of a topological symbology, mapping or “alphabet” enables the development of a completely new set of alignment algorithms that map the structural alignment problem into a sequence alignment problem. One advantage of this approach is that existing sequence programs may be employed, which are extremely mature and computationally efficient. Thus, the approach provides a new way of performing structural genomics while utilizing the well-established methodology of sequence bioinformatics.

The teachings herein extend the topological approach to consider non-distance related metrics to develop, or for use with, algorithms for structure alignment. The writhing number may be used as a local topological measure or parameter. The writhing number may, for example, describe the curvature of the protein backbone formed from short segments of repeating units, for example alpha carbon atoms or nitrogen atoms. This calculation provides a local topological profile of each protein. Likewise, the writhing number may be employed for other multi-dimensional structures, including but not limited to polymer structures.

The values for the writhing number may be encoded into a symbology (e.g., “alphabet”) or mapping. For example, writhing numbers may be encoded into a 20 character symbology (e.g., A, B, C, . . . R, S, T). As described in detail below, the symbology may be created, formed or defined by binning a histogram of all parameters or values (e.g., writhing numbers) and assigning each bin a character from a set of characters.

The approach may also employ one or more substitution or scoring matrices for assigning scores using conventional sequence analysis packages or software, or specially developed sequence analysis packages or software. Thus the approach allows the implementation and optimization of existing sequence bioinformatic algorithms, using a new symbology, mapping or “alphabet” and scoring system. Such algorithms may be analogized as the “topological version” of Smith Waterman and/or Needleman Wunsch pair-wise alignment (high quality pair alignments), BLAST and FASTA (database searching), CLUSTALW (multiple structure alignment.

Many of the processes and methods described herein may be implement via software instructions stored on a computer-readable medium, and executable by a computing system. This approach may be used, for example, for protein structure comparison, database searching, multiple structure alignment, sequence-structure alignment and homology modeling.

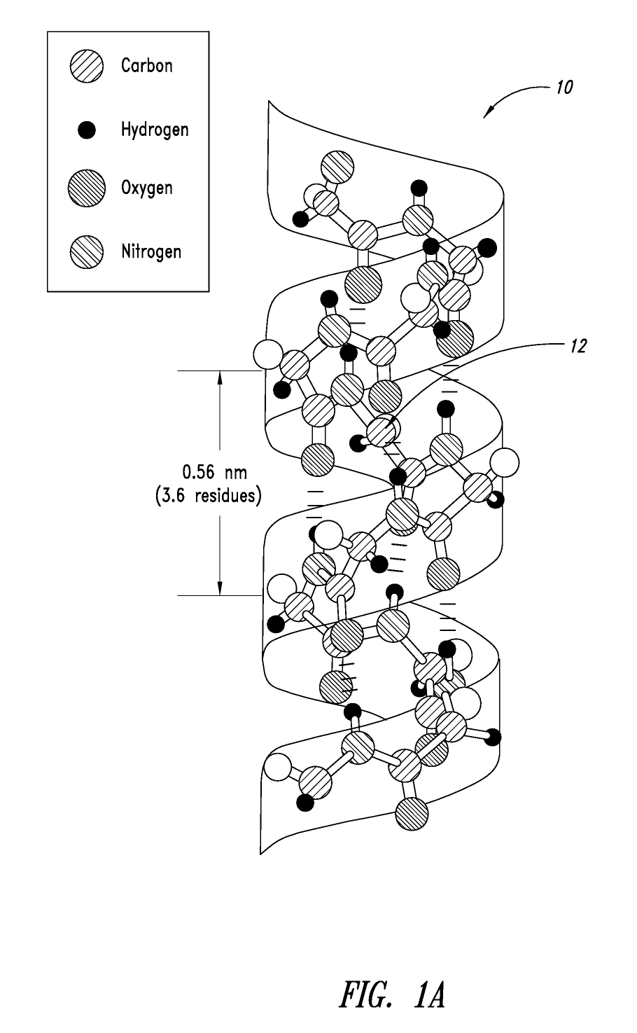

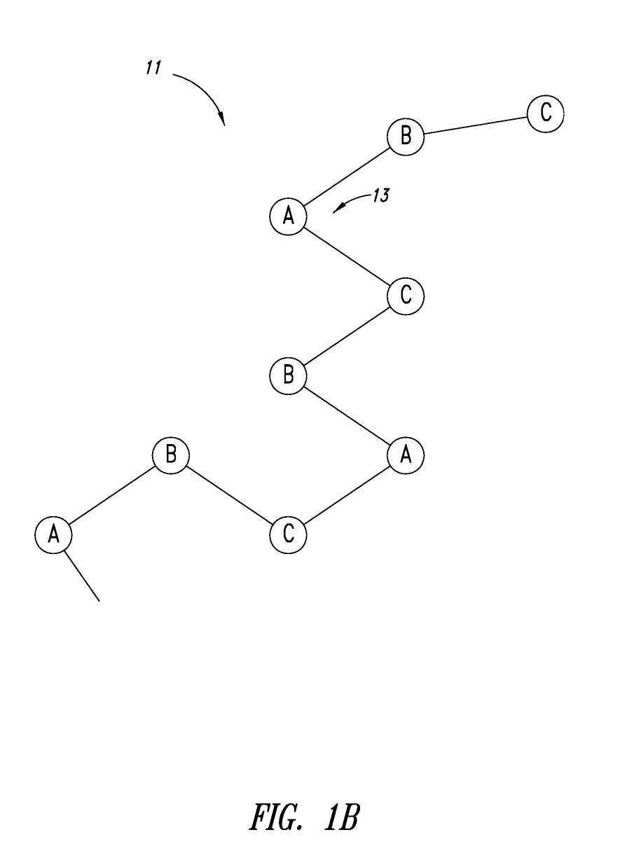

FIG. 1A shows a multi-dimensional structure in the form of a protein 10 composed of a plurality of amino acids 12 (only one enumerated for clarity of the Figure). The amino acids 12 may, for example take the form of: alanine, asparagines or aspartate, cysteine, glutamate, phenylalanine, glycine, histidine, isoleucine, lysine, leucine, methionine, proline, glutamine, arginine, serine, threonine, valine, tryptophan, and/or tyrosine.

FIG. 1B shows a multi-dimensional structure in the form of a polymer 11 formed by repeating substructures 13, according to an illustrated embodiment. While some embodiments are discussed below with specific reference to the protein 10, the repetitive substructures 13 of the of the polymer 11 can be analyzed in a similar fashion to that of the protein 10. Thus, the specific application of the teaching herein to polymers, as represented by the polymer 11 will not be repeated in the interest of clarity and brevity.

FIG. 2 shows a local segment or substructure 14 of the structure in the form of four (4)alpha carbons α₁, α₂, α₃, α₄. the local segment or substructure may comprise an amino acid, or may comprise some other substructure. A local segment or substructure 14 may include other, or different repeating units, for example four nitrogen atoms.

FIG. 2 also shows how a topographical parameter that represents the multi-dimensional topology of a local segment or substructure of the structure (e.g. protein, polymer, etc.) may be determined for the local segment or structure, according to one illustrated embodiment. In particular, the approach will be illustrated and discussed using the writhe number as an illustrative example of a topological parameter. Other embodiments may employ other topographical parameters.

The writhe number is used as a local measure of chain topology. Originally used to describe closed circular DNA, the writhe of a curve has recently been extended to include the measurement of open, polygonal curves. The writhe number of a protein backbone structure can be computed for the polygonal curve associated with four or more alpha carbons, or alternatively with any four other repeating units, for example nitrogen atoms.

In particular, a pair of vectors 16a, 16b are defined between the repeating units (e.g., alpha carbons), such that end points of the vectors 16a, 16b are not coincident. Thus, for example, a first vector 16a is defined from a first alpha carbon α₁ to a second alpha carbon α₂ and a second vector 16b from a third alpha carbon α₃ to a fourth alpha carbon α₄.

Rays r₁₃, r₁₄ may be defined between the first alpha carbon α₁ and the third and fourth alpha carbons α₃, α₄, respectively. Likewise, rays r₂₃, r₂₄ may be defined between the second alpha carbon α₂ and the third and fourth alpha carbons α₃, α₄, respectively. Under knot theory, the projection of these rays r₁₃, r₁₄, r₂₃, r₂₄ form a polygonal curved surface on the inner surface of a sphere. The signed area enclosed by the polygonal curved surface is the writhe number of the local segment or substructure.

Other embodiments may include more points (e.g., alpha carbons atoms or nitrogen atoms) in the window or local segment or substructure. Such embodiments may determine a writhe number for each combination of pairs for which the endpoints of the vectors are not coincident.

Other embodiments may employ higher order topological invariants, in addition to, or in place of the first order invariant writhe number. Such invariants may be taught in Rogen and Bohr, Mathematical Bioscience, 2003, vol.182, pages 167-181; and/or Roger and Fain, Proceedings of the National Academy of Science, 2003, Vol.100, pages 119-124.

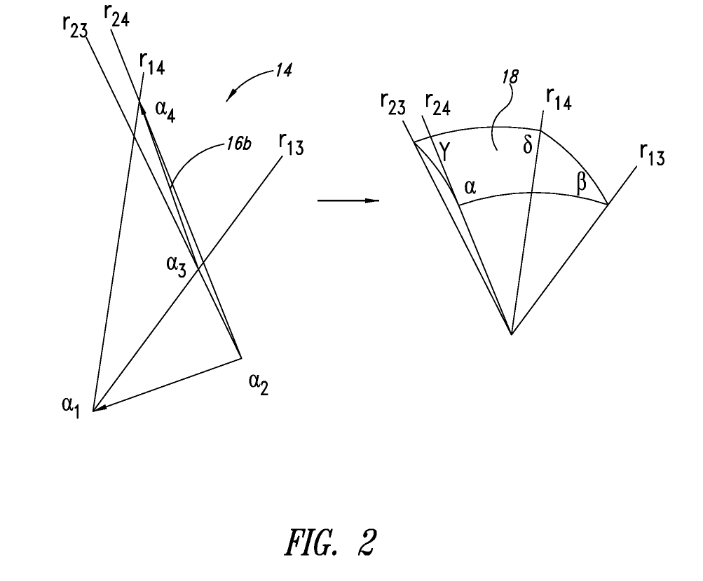

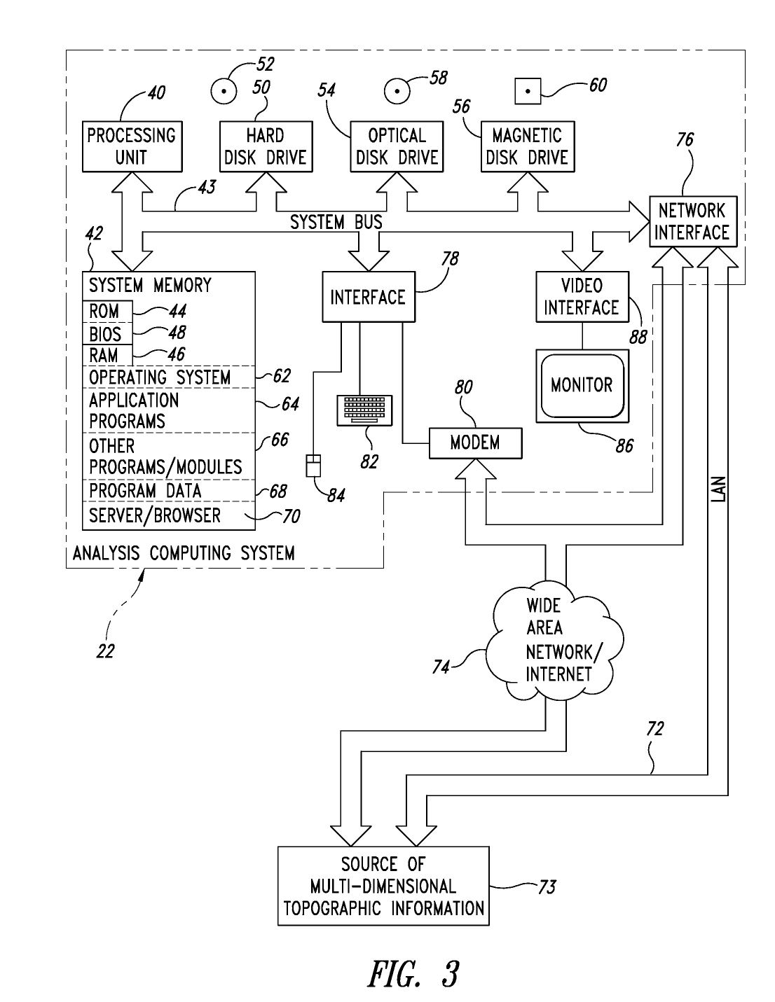

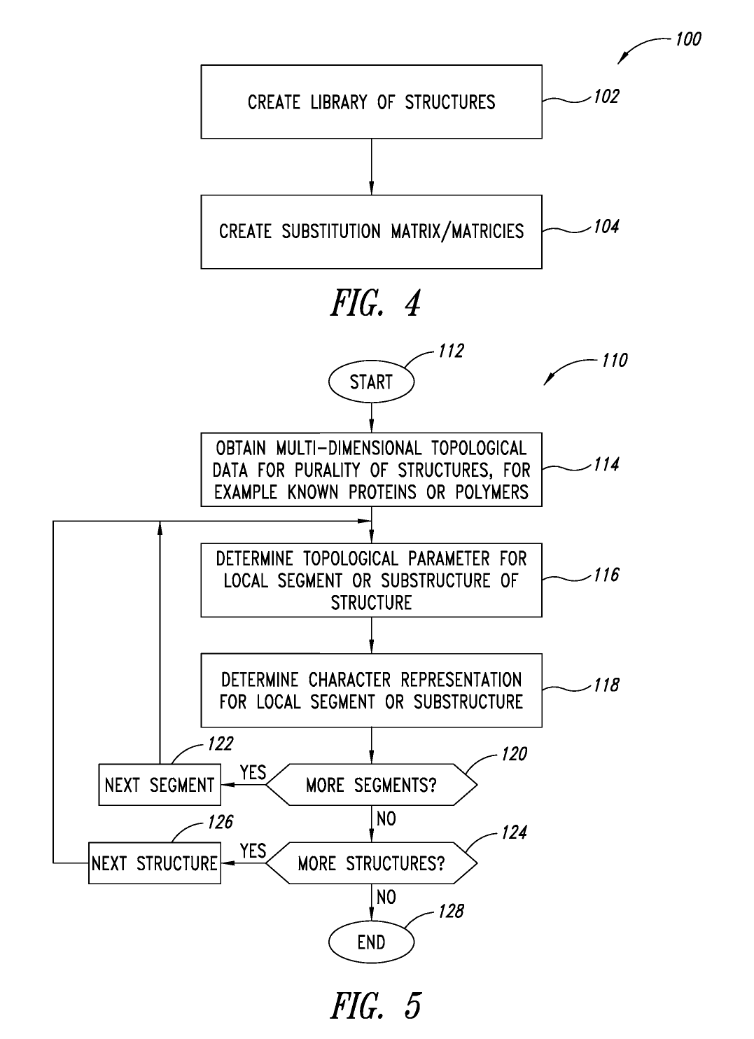

FIG. 3 and the following discussion provide a brief and general description of a suitable computing environment in which embodiments of the invention can be implemented, particularly those of the methods illustrated in FIGS. 4-14. Although not required, embodiments will be described in the general context of computer-executable instructions, such as program application modules, objects or macros being executed by a computer. Those skilled in the relevant art will appreciate that the invention can be practiced with other computing system configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The subject matter of FIG. 3 and the following discussion may be generally or specifically relevant to computing systems suitable for use as any one or more of the analysis computing systems 22. In the interest of brevity, only significant differences in hardware and operation of the various computing systems will be set out and discussed separately.

Referring to FIG. 3, an analysis computing system 22 includes a processing unit 40, a system memory 42, and a system bus 43 that couples various system components including the system memory 42 to the processing unit 40. The analysis computing system 22 will at times be referred to in the singular herein, but this is not intended to limit the application to a single analysis computing system 22 since in typical embodiments, there will be more than one analysis computing system 22 or other device involved. Other computing systems may be employed, such as conventional and personal computers, where the size or scale of the system allows. The processing unit 40 may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 3 are of conventional design. As a result, such blocks need not be described in further detail herein, as they will be understood by those skilled in the relevant art.

The system bus 43 can employ any known bus structures or architectures, including a memory bus with memory controller, a peripheral bus, and a local bus. The system memory 42 includes read-only memory (“ROM”) 44 and random access memory (“RAM”) 46. A basic input/output system (“BIOS”) 48, which can form part of the ROM 44, contains basic routines that help transfer information between elements within the analysis computing system 22, such as during startup.

The analysis computing system 22 also includes a hard disk drive 50 for reading from and writing to a hard disk 52, and an optical disk drive 54 and a magnetic disk drive 56 for reading from and writing to removable optical disks 58 and magnetic disks 60, respectively. The optical disk 58 can be read by a CD-ROM, while the magnetic disk 60 can be a magnetic floppy disk or diskette. The hard disk drive 50, optical disk drive 54 and magnetic disk drive 56 communicate with the processing unit 40 via the bus 43. The hard disk drive 50, optical disk drive 54 and magnetic disk drive 56 may include interfaces or controllers (not shown) coupled between such drives and the bus 43, as is known by those skilled in the relevant art. The drives 50, 54 and 56, and their associated computer-readable media, provide non-volatile storage of computer readable instructions, data structures, program modules and other data for the computing system 22. Although the depicted analysis computing system 22 employs hard disk 52, optical disk 58 and magnetic disk 60, those skilled in the relevant art will appreciate that other types of computer-readable media that can store data accessible by a computer may be employed, such a magnetic cassettes, flash memory cards, digital video disks (“DVD”), Bernoulli cartridges, RAMs, ROMs, smart cards, etc.

Program modules can be stored in the system memory 42, such as an operating system 62, one or more application programs 64, other programs or modules 66 and program data 68. The system memory 42 may also include a networking application 70, for example a Web server application and/or Web client or browser application for permitting the analysis computing system 22 to exchange data with sources via the Internet, corporate Intranets, or other networks as described below, as well as with other server applications on server computers such as those further discussed below. The networking application 70 in the depicted embodiment is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available such those available from America Online and Microsoft of Redmond, Wash.

While shown in FIG. 3 as being stored in the system memory 42, the operating system 62, application program 64, and other programs/modules 66, program data 68 and networking application 70 can be stored on the hard disk 52 of the hard disk drive 50, the optical disk 58 of the optical disk drive 54 and/or the magnetic disk 60 of the magnetic disk drive 56.

The analysis computing system 22 can operate in a networked environment using logical connections to a source of multi-dimensional topographic information 73 such as one or more remote computers or networks, or laboratory equipment, for example a micro total analysis system (μTAS). The analysis computing system 22 may be logically connected to one or more other analysis computing systems (not shown) and/or the source of multi-dimensional topographic information 73 under any known method of permitting computers to communicate, such as through a local area network (“LAN”) 72, or a wide area network (“WAN”) including, for example, the Internet 74. Such networking environments are well known including wired and wireless enterprise-wide computer networks, intranets, extranets, and the Internet. Other embodiments include other types of communication networks such as telecommunications networks, cellular networks, paging networks, and other mobile networks. When used in a LAN networking environment, the analysis computing system 22 is connected to the LAN 72 through an adapter or network interface 76 (communicative linked to the system bus 43). When used in a WAN networking environment, the analysis computing system 22 may include an interface 78 and modem 80 or other device, such as the network interface 76, for establishing communications over the WAN/Internet 74.

The modem 80 is shown in FIG. 3 as communicatively linked between the interface 78 and the WAN/Internet 74. In a networked environment, program modules, application programs, or data, or portions thereof, can be stored in the analysis computing system 22 for provision to the networked computers. In one embodiment, the analysis computing system 22 is communicatively linked through the LAN 72 or WAN/Internet 74 with TCP/IP middle layer network protocols; however, other similar network protocol layers are used in other embodiments, such as user datagram protocol (“UDP”). Those skilled in the relevant art will readily recognize that the network connections shown in FIG. 3 are only some examples of establishing communications links between computers, and other links may be used, including wireless links.

While in most instances the analysis computing system 22 will operate automatically, an operator can enter commands and information into the analysis computing system 22 through optional input devices, such as a keyboard 82, and a pointing device, such as a mouse 84. Other input devices can include a microphone, joystick, scanner, etc. These and other input devices are connected to the processing unit 40 through the interface 78, such as a serial port interface that couples to the bus 43, although other interfaces, such as a parallel port, a game port, or a wireless interface, or a universal serial bus (“USB”) can be used. A monitor 86 or other display device is coupled to the bus 43 via a video interface 88, such as a video adapter. The analysis computing system 22 can include other output devices, such as speakers, printers, etc.

FIG. 4 is a high level flow diagram of a method 100 of preparing a database useful in performing analysis of multi-dimensional structures. The database may be stored on a computer-readable medium, for example the hard disk 52, optical disks 58 and/or magnetic disks 60 (FIG. 3).

The database may include a library of structures to encode multi-dimensional topographic information into sequence information, and may include one or more substitution matrices for scoring results of sequence alignment analysis, according to an illustrated embodiment.

At 102, the analysis computing system 22 creates a library of structures. As discussed below, the library of structures may take the form of a symbology or mapping of topographical parameters to a set of characters. For example, the library of structures may include sets or groups of writhe numbers which are mapped to characters from a set of characters (e.g., portion of the English alphabet). As discussed in more detail below, the symbology or mapping may be implemented by assigning characters to groups or “bins” of writhe numbers, the groups or bins defined by a range, typically having an upper and a lower limit.

For example, the writhe numbers may be encoded into a 20 character symbology. Such symbology may, for example, be represented by twenty letters, for instance A, B, C . . . . R, S, T. Additional or new bins or groups can be easily added by expanding the size of the symbology, for example to 22 characters.

The symbology may employ characters other than those of the English alphabet. For example, the symbology may employ letters from other alphabets, such as Cyrillic, may employ numbers, special symbols, or even barcode or other machine-readable symbols.

At 104, the analysis computing system 22 may create one or more substitution matrix or matrices. As discussed in more detail below, the substitution matrix or matrices allow the scoring or ranking of results, particularly where results are not exact matches for search criteria. Thus, for example, the scoring matrix may allow less then exact matches (hits) to be ranked in a highest-to-lowest order.

For example, a scoring matrix for substitutions in the topological symbology may be determined using a block alignment approach similar to that used in calculating the BLOSUM substitution matrix. Using this matrix (referred to as TBLOSUM) and the topographical symbology (e.g., re-sequenced structure data bank), standard sequence alignment methods (e.g., Smith-Waterman, CLUSTALW) may be used to perform sequence analysis (e.g., structure alignments).

FIG. 5 is a mid-level flow diagram of a method 110 of creating a library of structures, for example a library of protein topographical parameters and corresponding character representations, useful in performing the method 100 of FIG. 4, according to an illustrated embodiment.

The method 110 starts at 112, for example in response to a call at 102 of the method 100. At 114, the analysis computing system 22 obtains multi-dimensional topological information or data for a plurality of structures. For example, the analysis computing system 22 may receive multi-dimensional topological information or data from the source of multi-dimensional topological information or data 73 (FIG. 3). For instance, analysis computing system 22 may receive topographical data corresponding to a portion or all of the protein structures in the RCSB Protein Data Bank (PDB).

At 116, the analysis computing system 22 determines the topological parameter for a local segment or substructure of a structure. For example, the analysis computing system 22 may compute one or more writhe numbers, as discussed below with reference to FIG. 6.

At 118, the analysis computing system 22 determines a character representation for the local segment or substructure based at least in part on the topological parameter. For example, the analysis computing system 22 may employ a binning methodology, such as that discussed below with reference to FIG. 7.

At 120, the analysis computing system 22 determines whether there are more local segments or substructures to analyze. If there are more local segments or substructures to analyze, the analysis computing system 22 increments to select the next local segment or substructure at 122 and returns control to 116. If there are no more local segments or substructures to analyze, control passes to 124.

At 124, the analysis computing system 22 determines whether there are more structures to analyze. If there are more structures to analyze, the analysis computing system 22 increments to select the next structure at 126, and returns control to 116. If there are no more structures to analyze, control passes to 128 where the method 110 terminates.

FIG. 6 is a low level flow diagram of a method 140 of determining topological parameters of local segments or substructures of a multi-dimensional structure such as a protein, polymer or other structure, and useful in the performing the method 110 of FIG. 5, according to one illustrated embodiment.

At 142, the analysis computing system 22 selects a local segment or substructure for analysis. The local segment or substructure should be selected such that a topographical parameter may be determined for the local segment or substructure. For example, a local segment or substructure including four (4) or more distinct points or elements may allow the determination of a writhe number indicative of the three dimensional topology of the local segment or substructure. Such a local segment or substructure is illustrated in FIG. 2, where the local segment includes four alpha carbons.

At 144, the analysis computing system 22 determines the topographical parameter in the form of a writhing number of the local segment or substructure.

A sliding window approach may be employed for calculating the local topology (topographical parameter, e.g. writhing number) down the length of the structure (e.g., protein chain or polymer). For example, a fixed window may be used, the window being moved down the structure so as to encompass one or more of the local segments or substructures from one or more adjacent windows. Thus, for example, a first writhe number may be determined using the first four alpha carbons (e.g., amino acid), then a second writhe number may be determined using the second through fifth alpha carbons, followed by a third writhe number using the third through sixth alpha carbons. Alternatively, for example, a first writhe number may be determined using the first five alpha carbons, then a second writhe number may be determined using the third through seventh alpha carbons, followed by a third writhe number using the fifth through ninth alpha carbons. The method may employ other window sizes greater than four, and other amounts of overlap with adjacent windows, or may omit overlap of windows.

Alternatively, the window may be variable. For example, the widow may be incrementally expanded until the determined writhe number based on the local structure with the window equals or exceeds a threshold writhe number.

By encoding the distributions of writhe numbers across all the structures in the protein databank (PDB), it is possible to represent protein topologies in a finite character symbology or “alphabet”. As noted above, this encoding transforms the topological structure alignment problem into a sequence alignment problem and allows the well-established algorithms of sequence alignment to be employed. Topological alignment offers distinct advantages over structural alignment in Cartesian coordinates as it better handles structural subtleties associated with slight twists and bends that distort one structure relative to another.

FIG. 7 is a low level flow diagram of a method 150 of determining a character representation for the local segment or substructure based on the determined topological parameters, useful in performing the method of FIG. 5, according to one illustrated embodiment.

Binning may be used to create, form or otherwise define the symbology or mapping between the topological parameters and the character representations. Once created, formed or defined, the symbology or mapping may be used in converting multi-dimensional topologies into sequence representations. The symbology or mapping may be updated from time-to-time, for example adding new topological representations and/or characters, reassigning relationships between topological representations and characters, and/or deleting topological representations and/or characters.

At 152, the analysis computing system 22 bins the topographic parameters. The symbology or mapping may be created, formed or defined by binning a histogram of all values (e.g., writhing numbers) for a set of structures.

At 154, the analysis computing system 22 assigns characters as a result of the binning. Each bin may be assigned a character (e.g., letters A-T). This procedure allows standard sequence alignment algorithms to be used to compare the topological profiles. For example, Keck Graduate Institute has “re-sequenced” and stored all 51,593 proteins available in the RCSB Protein Data Bank (PDB) to a proprietary database for quick access.

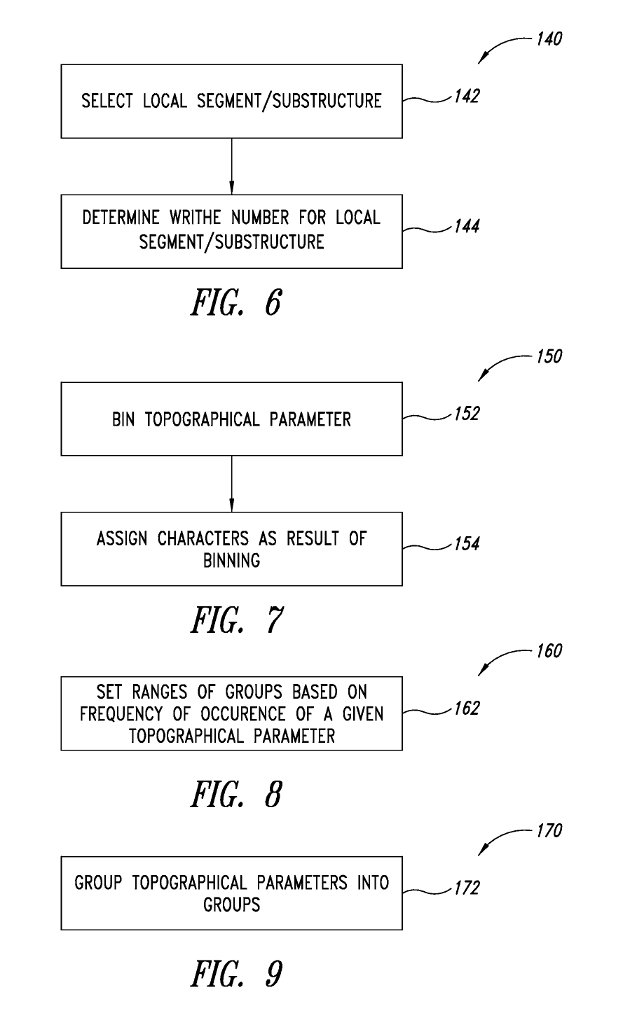

FIG. 8 is a low level flow diagram of a method 160 of setting ranges for binning, useful in performing the method of FIG. 7, according to one illustrated embodiment.

At 162, the analysis computing system 22 sets ranges of groups as an optional part of the binning 152 (FIG. 6). The ranges of the bins or groups may be determined based at least in part of a frequency of occurrence of the respective determined topological parameters over a number of structures. Alternatively, or additionally, binning may include determining the ranges of the bins or group such that each group includes an approximately same number of occurrences of the respective determined topological parameters over the number of structures. Thus, writhe numbers that appear frequently over the set of structures may be assigned to relatively narrow bins or groups, while those occurring less frequently may be assigned to large bins or groups. Thus, the number of occurrences of writhe numbers, resulting from the set of structures, may be approximately equally distributed across the bins or groups.

Other alternatives for binning are possible, including weighting certain preferred topographical parameters (e.g., writhe numbers) by appropriately adjusting the range of the bin or group.

FIG. 9 is a low level flow diagram of a method 170 of grouping topographical parameters as part of binning, useful in performing the method of FIG. 7, according to one illustrated embodiment.

At 172, the analysis computing system 22 groups the topographical parameters into the groups. Such may occur as a distinct act, after the ranges of the bins or groups are set (160).

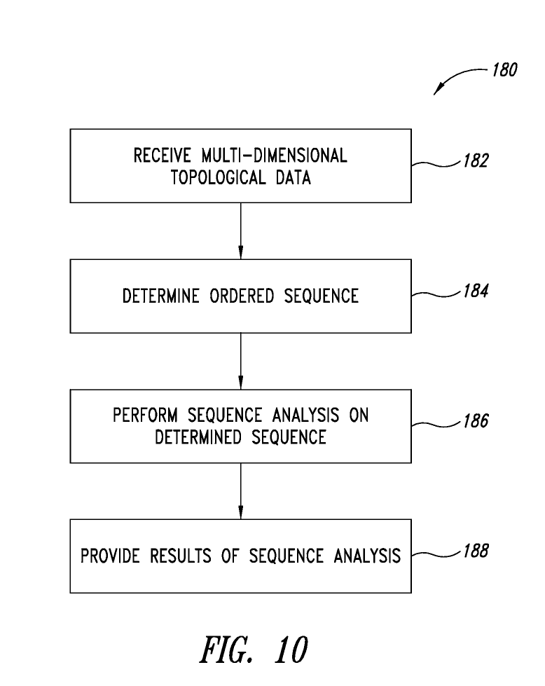

FIG. 10 is a high level flow diagram illustrating a method 180 of analyzing a multi-dimensional structure such as a protein, polymer or other structure using an existing library of structures, according to one illustrated embodiment.

At 182, the analysis computing system 22 receives multi-dimensional topographic information or data. For example, the analysis computing system 22 may receive the multi-dimensional topographic information or data from a source of multi-dimensional topographic information 73 such as one or more remote computers or networks, or laboratory equipment, for example a micro total analysis system (μTAS). The analysis computing system 22 may receive the multi-dimensional topographic information or data via LAN 72 or a WAN 74 (FIG. 3).

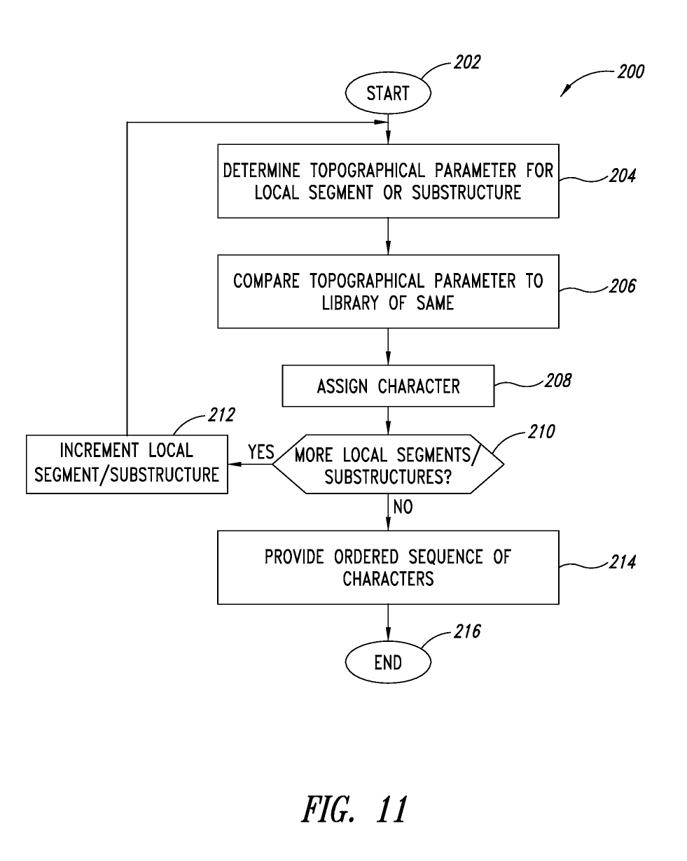

At 184, the analysis computing system 22 determines a one-dimensional ordered sequence for the multi-dimensional topographic information or data. For example, as discussed below with reference to FIG. 11, the analysis computing system 22 may determine an ordered sequence of characters corresponding to topographical parameters (e.g., writhe numbers) for the local segments or substructures composing the structure.

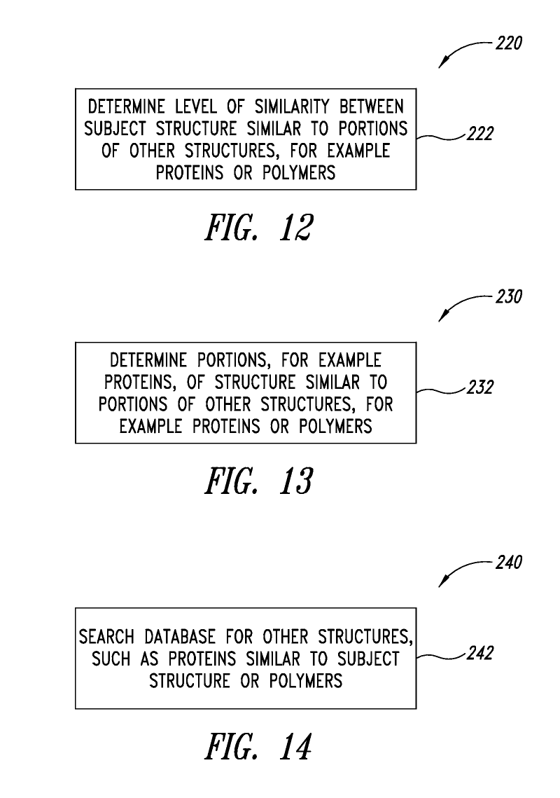

At 186, the analysis computing system 22 performs a sequence analysis on the determined one-dimensional ordered sequence. As discussed below with reference to FIGS. 12-13, the sequence analysis may take a variety of forms. For example, the sequence analysis may determine a level of similarity between a subject structure and another structure. Also for example, the sequence analysis may determine which portions of a subject structure are similar to portions of other structures. As a further example, the sequence analysis may search a database or catalog for other structures similar to the subject structure. For example, the local Smith-Waterman alignment and the CLUSTALW may be used to perform high quality pair-wise alignment and multiple structure alignment, respectively. These algorithms are very fast and out compete existing programs in their computational efficiency.

At 188, the analysis computing system 22 provides results of the sequence analysis. For example, the analysis computing system may remotely provide results via LAN 72 or a WAN 74 (FIG. 3).

FIG. 11 is a mid-level flow diagram illustrating a method 200 of determining an ordered sequence, for representing in one-dimension a topology of a multi-dimensional structure such as a protein, according to one illustrated embodiment. The method 200 may be useful in the performing the method of FIG. 10.

The method 200 starts at 202, for example in response to a call at 184 of the method (FIG. 10).

At 204, the analysis computing system 22 determines the topographic parameter for the local segment or substructure. For example, the analysis computing system 22 may employ the method 140 (FIG. 6) described above.

At 206, the analysis computing system 22 compares the topographical parameter to topographical parameters in a library of structures. The library of structures may be that created, formed or defined at 102 of method 100 (FIG. 4) described above. The analysis computing system 22 determines the appropriate group or bin in which the topological parameter would be classed.

At 208, the analysis computing system 22 assigns a character from the character set of the symbology based on the comparison 206. The analysis computing system 22 uses the character assigned or otherwise associated with the group or bin identified at 206.

At 210, the analysis computing system 22 determines if there are more local segments or substructures to be analyzed. If there are more local segments or substructures to be analyzed, analysis computing system 22 increments to the next local segment or substructure at 212, and passes control back to 204. If there are no more local segments or substructures to be analyzed, the analysis computing system 22 passes control to 214.

At 214, the analysis computing system 22 provides the resulting ordered sequence of characters, and terminates the method 200 at 216.

FIG. 12 is a mid-level flow diagram illustrating a method 220 of performing sequence analysis using an ordered sequence, according to one illustrated embodiment. The method 220 may be useful in performing the method of FIG. 10.

At 222, the analysis computing system 22 determines a level of similarity between a subject structure and another structure. For example, the method 220 may determine precise matches between topological structures using sequence analysis. Alternatively or additionally, the method 220 may determine one or more values indicating how closely topological structures match using sequence analysis. The method 220 may, for example, employ Smith Waterman and/or Needleman Wunsch pair-wise alignment.

FIG. 13 is a flow diagram illustrating a method 230 of performing sequence analysis using an ordered sequence, according to one illustrated embodiment. The method 230 may be useful in performing the method of FIG. 10.

At 232, the analysis computing system 22 may determine which portions of a subject structure are similar to portions of other structures. For example, the method 230 may employ CLUSTALW.

FIG. 14 is a flow diagram illustrating a method 240 of performing sequence analysis using an ordered sequence, according to one illustrated embodiment. The method 240 may be useful in performing the method of FIG. 10.

At 242, the analysis computing system 22 may search a database or catalog for other structures similar to the subject structure. For example, the method 240 may employ BLAST and/or FASTA.

A set of structure bioinformatic tools based on local topological properties has been described.

The performance of the topological encoded sequence algorithm has been tested in pair-wise alignment and multiple structure alignments. They compare favorably with existing algorithms in terms of the ability to align “difficult” protein structures. They outperform existing algorithms in computational speed and efficiency.

This approach may also be extended into homology modeling. In this case, the topological alphabet will replace sequence information in defining probabilistic models for homology modeling.

The performance of programs for pair-wise local topological alignment (TLOCAL) and multiple topological structure alignment (TCLUSTALW) are readily adapted from existing code for Smith-Waterman pair-wise alignment and multiple sequence alignment using CLUSTALW. The alignment algorithms use a blocked scoring matrix (TBLOSUM) generated using the frequency of changes in the topological symbology or alphabet of a block of protein structures. TLOCAL was tested on a set of 10 difficult proteins and found to give high quality alignments that compare favorably to those generated by existing pair-wise alignment programs. A set of protein comparison involving hinged structures was also analyzed and TLOCAL was also seen to compare favorably to other alignment methods. TCLUSTALW was tested on a family of protein kinases and reveal conserved regions similar to those previously identified by a hand alignment. Findings to date demonstrate that the encoding of the writhing number as a topological measure allows high quality structure alignments to be generated using standard algorithms of sequence alignment. The teachings herein can be extended to other standard bioinformatic methodologies. It is noted that those of skill in the art sometimes use the terms topology, geometry, tertiary structure and/or conformal structure interchangeably.

Some exemplary scoring matrices which may be particular suitable for use in the above described approaches are set out below. The particular matrix may be selected based on the size of the window and/or the level of similarity. For example, matrices may be optimized for scoring at different length scales (e.g., 4, 5, 6 and 7 amino acid length fragments, i.e., window sizes) allowing the capture of different sized features. Additionally matrices may be optimized for different levels of similarity of sequences (e.g., 45%, 62% and 80% similarity) allowing searching for distantly related structures (e.g., 45%) and/or closely related structures (e.g., 80%).

Table A shows a matrix particularly suitable for a window size of four (4) and a cluster 45 (i.e., similarity of 45%.)

TABLE A

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 4 | 1 | −1 | −2 | −3 | −4 | −4 | −3 | −3 | −3 | −3 | −4 | −6 | −8 | −8 | −8 | −8 | −8 | −7 |
| C | 4 | 6 | 5 | 2 | 0 | −1 | −2 | −2 | −2 | −2 | −2 | −3 | −5 | −7 | −8 | −8 | −9 | −8 | −8 | −7 |
| D | 1 | 5 | 6 | 5 | 2 | 0 | −1 | −1 | −1 | −2 | −3 | −3 | −5 | −7 | −8 | −9 | −9 | −9 | −9 | −7 |
| E | −1 | 2 | 5 | 5 | 4 | 2 | 1 | 0 | −1 | −1 | −2 | −3 | −5 | −7 | −9 | −9 | −9 | −9 | −9 | −8 |
| F | −2 | 0 | 2 | 4 | 5 | 4 | 3 | 1 | 0 | −1 | −3 | −4 | −5 | −8 | −9 | −10 | −10 | −10 | −9 | −8 |
| G | −3 | −1 | 0 | 2 | 4 | 5 | 5 | 3 | 1 | −1 | −2 | −4 | −5 | −8 | −9 | −10 | −10 | −10 | −10 | −9 |
| H | −4 | −2 | −1 | 1 | 3 | 5 | 6 | 5 | 3 | 0 | −2 | −4 | −6 | −8 | −9 | −9 | −10 | −10 | −9 | −8 |
| I | −4 | −2 | −1 | 0 | 1 | 3 | 5 | 6 | 5 | 1 | −2 | −3 | −5 | −8 | −9 | −10 | −10 | −10 | −9 | −9 |
| K | −3 | −2 | −1 | −1 | 0 | 1 | 3 | 5 | 6 | 4 | 0 | −2 | −4 | −7 | −8 | −9 | −9 | −9 | −9 | −8 |
| L | −3 | −2 | −2 | −1 | −1 | −1 | 0 | 1 | 4 | 6 | 4 | 1 | −2 | −5 | −7 | −7 | −8 | −8 | −7 | −6 |
| M | −3 | −2 | −3 | −2 | −3 | −2 | −2 | −2 | 0 | 4 | 6 | 4 | 0 | −4 | −5 | −6 | −7 | −7 | −7 | −6 |
| N | −3 | −3 | −3 | −3 | −4 | −4 | −4 | −3 | −2 | 1 | 4 | 6 | 3 | −1 | −3 | −4 | −5 | −5 | −5 | −4 |
| P | −4 | −5 | −5 | −5 | −5 | −5 | −6 | −5 | −4 | −2 | 0 | 3 | 5 | 3 | 1 | −1 | −2 | −2 | −2 | −2 |
| Q | −6 | −7 | −7 | −7 | −8 | −8 | −8 | −8 | −7 | −5 | −4 | −1 | 3 | 4 | 3 | 2 | 1 | 0 | 0 | −1 |
| R | −8 | −8 | −8 | −9 | −9 | −9 | −9 | −9 | −8 | −7 | −5 | −3 | 1 | 3 | 3 | 2 | 2 | 1 | 1 | 0 |
| S | −8 | −8 | −9 | −9 | −10 | −10 | −9 | −10 | −9 | −7 | −6 | −4 | −1 | 2 | 2 | 3 | 2 | 2 | 1 | 0 |
| T | −8 | −9 | −9 | −9 | −10 | −10 | −10 | −10 | −9 | −8 | −7 | −5 | −2 | 1 | 2 | 2 | 2 | 2 | 2 | 1 |
| V | −8 | −8 | −9 | −9 | −10 | −10 | −10 | −10 | −9 | −8 | −7 | −5 | −2 | 0 | 1 | 2 | 2 | 3 | 3 | 2 |
| W | −8 | −8 | −9 | −9 | −9 | −10 | −9 | −9 | −9 | −7 | −7 | −5 | −2 | 0 | 1 | 1 | 2 | 3 | 3 | 3 |
| Y | −7 | −7 | −7 | −8 | −8 | −9 | −8 | −9 | −8 | −6 | −6 | −4 | −2 | −1 | 0 | 0 | 1 | 2 | 3 | 4 |

Table B shows a matrix particularly suitable for a window size of four (4) and a cluster 62 (i.e., similarity of 62%.)

TABLE B

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 4 | 0 | −3 | −4 | −6 | −6 | −7 | −6 | −5 | −6 | −6 | −7 | −10 | −11 | −11 | −12 | −11 | −11 | −10 |
| C | 4 | 7 | 5 | 1 | −1 | −4 | −5 | −5 | −5 | −5 | −5 | −6 | −8 | −10 | −11 | −11 | −12 | −11 | −11 | −10 |
| D | 0 | 5 | 7 | 5 | 1 | −2 | −3 | −4 | −4 | −5 | −6 | −6 | −8 | −10 | −12 | −12 | −12 | −12 | −11 | −11 |
| E | −3 | 1 | 5 | 7 | 5 | 1 | −1 | −2 | −3 | −4 | −5 | −6 | −8 | −11 | −12 | −12 | −12 | −12 | −12 | −11 |
| F | −4 | −1 | 1 | 5 | 7 | 5 | 2 | 0 | −2 | −3 | −5 | −7 | −8 | −11 | −12 | −13 | −13 | −13 | −12 | −11 |
| G | −6 | −4 | −2 | 1 | 5 | 7 | 5 | 2 | 0 | −3 | −5 | −7 | −9 | −11 | −12 | −13 | −13 | −13 | −13 | −11 |
| H | −6 | −5 | −3 | −1 | 2 | 5 | 6 | 5 | 2 | −2 | −5 | −7 | −9 | −11 | −12 | −13 | −13 | −14 | −13 | −12 |
| I | −7 | −5 | −4 | −2 | 0 | 2 | 5 | 7 | 5 | 0 | −4 | −6 | −8 | −11 | −12 | −13 | −13 | −14 | −13 | −12 |
| K | −6 | −5 | −4 | −3 | −2 | 0 | 2 | 5 | 7 | 4 | −1 | −4 | −7 | −9 | −11 | −12 | −12 | −13 | −12 | −11 |
| L | −5 | −5 | −5 | −4 | −3 | −3 | −2 | 0 | 4 | 7 | 4 | 0 | −4 | −8 | −10 | −10 | −11 | −11 | −10 | −9 |
| M | −6 | −5 | −6 | −5 | −5 | −5 | −5 | −4 | −1 | 4 | 7 | 4 | −1 | −6 | −8 | −9 | −10 | −10 | −10 | −9 |
| N | −6 | −6 | −6 | −6 | −7 | −7 | −7 | −6 | −4 | 0 | 4 | 7 | 3 | −2 | −5 | −6 | −7 | −8 | −8 | −7 |
| P | −7 | −8 | −8 | −8 | −8 | −9 | −9 | −8 | −7 | −4 | −1 | 3 | 6 | 3 | 0 | −2 | −3 | −4 | −4 | −4 |
| Q | −10 | −10 | −10 | −11 | −11 | −11 | −11 | −11 | −9 | −8 | −6 | −2 | 3 | 4 | 3 | 1 | 0 | −1 | −2 | −2 |
| R | −11 | −11 | −12 | −12 | −12 | −12 | −12 | −12 | −11 | −10 | −8 | −5 | 0 | 3 | 4 | 3 | 2 | 1 | 0 | −1 |
| S | −11 | −11 | −12 | −12 | −13 | −13 | −13 | −13 | −12 | −10 | −9 | −6 | −2 | 1 | 3 | 3 | 3 | 2 | 1 | 0 |
| T | −12 | −12 | −12 | −12 | −13 | −13 | −13 | −13 | −12 | −11 | −10 | −7 | −3 | 0 | 2 | 3 | 3 | 3 | 2 | 0 |
| V | −11 | −11 | −12 | −12 | −13 | −13 | −14 | −14 | −13 | −11 | −10 | −8 | −4 | −1 | 1 | 2 | 3 | 3 | 3 | 2 |
| W | −11 | −11 | −11 | −12 | −12 | −13 | −13 | −13 | −12 | −10 | −10 | −8 | −4 | −2 | 0 | 1 | 2 | 3 | 4 | 3 |
| Y | −10 | −10 | −11 | −11 | −11 | −11 | −12 | −12 | −11 | −9 | −9 | −7 | −4 | −2 | −1 | 0 | 0 | 2 | 3 | 5 |

Table C shows a matrix particularly suitable for a window size of four (4) and a cluster 80 (i.e., similarity of 80%.)

TABLE C

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 3 | −2 | −5 | −6 | −8 | −9 | −9 | −8 | −7 | −7 | −8 | −9 | −11 | −12 | −12 | −13 | −12 | −12 | −11 |
| C | 3 | 7 | 4 | 0 | −3 | −6 | −7 | −8 | −7 | −7 | −8 | −8 | −10 | −11 | −12 | −12 | −13 | −13 | −12 | −11 |
| D | −2 | 4 | 7 | 4 | 0 | −4 | −6 | −7 | −7 | −7 | −8 | −9 | −10 | −12 | −14 | −14 | −13 | −13 | −13 | −12 |
| E | −5 | 0 | 4 | 7 | 4 | 0 | −4 | −5 | −6 | −6 | −7 | −8 | −10 | −12 | −13 | −13 | −13 | −14 | −13 | −13 |
| F | −6 | −3 | 0 | 4 | 7 | 4 | 0 | −3 | −4 | −6 | −7 | −8 | −10 | −13 | −14 | −14 | −14 | −14 | −14 | −13 |
| G | −8 | −6 | −4 | 0 | 4 | 6 | 4 | 0 | −3 | −5 | −8 | −9 | −11 | −13 | −15 | −15 | −15 | −15 | −14 | −13 |
| H | −9 | −7 | −6 | −4 | 0 | 4 | 6 | 4 | 0 | −4 | −8 | −9 | −11 | −14 | −15 | −16 | −16 | −16 | −15 | −14 |
| I | −9 | −8 | −7 | −5 | −3 | 0 | 4 | 7 | 4 | −2 | −7 | −9 | −10 | −13 | −14 | −15 | −15 | −16 | −14 | −13 |
| K | −8 | −7 | −7 | −6 | −4 | −3 | 0 | 4 | 7 | 3 | −3 | −6 | −8 | −11 | −13 | −14 | −14 | −14 | −13 | −12 |
| L | −7 | −7 | −7 | −6 | −6 | −5 | −4 | −2 | 3 | 7 | 3 | −2 | −5 | −9 | −11 | −12 | −13 | −12 | −12 | −11 |
| M | −7 | −8 | −8 | −7 | −7 | −8 | −8 | −7 | −3 | 3 | 7 | 4 | −2 | −7 | −10 | −11 | −12 | −12 | −11 | −10 |
| N | −8 | −8 | −9 | −8 | −8 | −9 | −9 | −9 | −6 | −2 | 4 | 7 | 3 | −3 | −6 | −8 | −9 | −9 | −9 | −8 |
| P | −9 | −10 | −10 | −10 | −10 | −11 | −11 | −10 | −8 | −5 | −2 | 3 | 7 | 3 | 0 | −3 | −4 | −5 | −6 | −6 |
| Q | −11 | −11 | −12 | −12 | −13 | −13 | −14 | −13 | −11 | −9 | −7 | −3 | 3 | 6 | 4 | 1 | 0 | −2 | −3 | −3 |
| R | −12 | −12 | −14 | −13 | −14 | −15 | −15 | −14 | −13 | −11 | −10 | −6 | 0 | 4 | 5 | 4 | 2 | 0 | −1 | −2 |
| S | −12 | −12 | −14 | −13 | −14 | −15 | −16 | −15 | −14 | −12 | −11 | −8 | −3 | 1 | 4 | 4 | 4 | 2 | 1 | −1 |
| T | −13 | −13 | −13 | −13 | −14 | −15 | −16 | −15 | −14 | −13 | −12 | −9 | −4 | 0 | 2 | 4 | 4 | 4 | 2 | 0 |
| V | −12 | −13 | −13 | −14 | −14 | −15 | −16 | −16 | −14 | −12 | −12 | −9 | −5 | −2 | 0 | 2 | 4 | 4 | 4 | 2 |
| W | −12 | −12 | −13 | −13 | −14 | −14 | −15 | −14 | −13 | −12 | −11 | −9 | −6 | −3 | −1 | 1 | 2 | 4 | 5 | 4 |
| Y | −11 | −11 | −12 | −13 | −13 | −13 | −14 | −13 | −12 | −11 | −10 | −8 | −6 | −3 | −2 | −1 | 0 | 2 | 4 | 7 |

Table D shows a matrix particularly suitable for a window size of five (5) and a cluster 45 (i.e., similarity of 45%.)

TABLE D

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 7 | 4 | 1 | 0 | −2 | −2 | −2 | −2 | −2 | −2 | −2 | −2 | −3 | −5 | −7 | −9 | −9 | −9 | −10 | −9 |
| C | 4 | 6 | 4 | 2 | 0 | −1 | −1 | −2 | −1 | −2 | −2 | −2 | −3 | −5 | −8 | −8 | −9 | −10 | −10 | −10 |
| D | 1 | 4 | 5 | 4 | 2 | 1 | 0 | −1 | −1 | −1 | −2 | −2 | −3 | −5 | −8 | −8 | −9 | −9 | −10 | −9 |
| E | 0 | 2 | 4 | 4 | 4 | 2 | 1 | 0 | 0 | −1 | −2 | −2 | −4 | −5 | −8 | −9 | −10 | −10 | −10 | −10 |
| F | −2 | 0 | 2 | 4 | 4 | 4 | 3 | 1 | 0 | −1 | −2 | −3 | −4 | −6 | −8 | −10 | −10 | −11 | −11 | −11 |
| G | −2 | −1 | 1 | 2 | 4 | 4 | 4 | 3 | 1 | −1 | −2 | −3 | −4 | −6 | −8 | −10 | −10 | −10 | −11 | −10 |
| H | −2 | −1 | 0 | 1 | 3 | 4 | 4 | 4 | 2 | 0 | −1 | −3 | −4 | −6 | −8 | −10 | −10 | −10 | −11 | −11 |
| I | −2 | −2 | −1 | 0 | 1 | 3 | 4 | 5 | 4 | 1 | 0 | −2 | −3 | −5 | −8 | −10 | −11 | −11 | −11 | −11 |
| K | −2 | −1 | −1 | 0 | 0 | 1 | 2 | 4 | 5 | 4 | 2 | −1 | −2 | −5 | −8 | −9 | −10 | −10 | −10 | −10 |
| L | −2 | −2 | −1 | −1 | −1 | −1 | 0 | 1 | 4 | 5 | 4 | 1 | −2 | −4 | −7 | −8 | −9 | −9 | −9 | −9 |
| M | −2 | −2 | −2 | −2 | −2 | −2 | −1 | 0 | 2 | 4 | 5 | 4 | −1 | −4 | −6 | −7 | −8 | −8 | −9 | −9 |
| N | −2 | −2 | −2 | −2 | −3 | −3 | −3 | −2 | −1 | 1 | 4 | 6 | 3 | −2 | −5 | −7 | −7 | −8 | −8 | −8 |
| P | −3 | −3 | −3 | −4 | −4 | −4 | −4 | −3 | −2 | −2 | −1 | 3 | 7 | 4 | −2 | −5 | −6 | −6 | −7 | −6 |
| Q | −5 | −5 | −5 | −5 | −6 | −6 | −6 | −5 | −5 | −4 | −4 | −2 | 4 | 7 | 3 | −1 | −2 | −3 | −3 | −3 |
| R | −7 | −8 | −8 | −8 | −8 | −8 | −8 | −8 | −8 | −7 | −6 | −5 | −2 | 3 | 4 | 3 | 2 | 1 | 1 | 1 |
| S | −9 | −8 | −8 | −9 | −10 | −10 | −10 | −10 | −9 | −8 | −7 | −7 | −5 | −1 | 3 | 3 | 3 | 2 | 2 | 1 |
| T | −9 | −9 | −9 | −10 | −10 | −10 | −10 | −11 | −10 | −9 | −8 | −7 | −6 | −2 | 2 | 3 | 3 | 3 | 3 | 2 |
| V | −9 | −10 | −9 | −10 | −11 | −10 | −10 | −11 | −10 | −9 | −8 | −8 | −6 | −3 | 1 | 2 | 3 | 3 | 3 | 3 |
| W | −10 | −10 | −10 | −10 | −11 | −11 | −11 | −11 | −10 | −9 | −9 | −8 | −7 | −3 | 1 | 2 | 3 | 3 | 3 | 3 |
| Y | −9 | −10 | −9 | −10 | −11 | −10 | −11 | −11 | −10 | −9 | −9 | −8 | −6 | −3 | 1 | 1 | 2 | 3 | 3 | 4 |

Table E shows a matrix particularly suitable for a window size of five (5) and a cluster 62 (i.e., similarity of 62%.)

TABLE E

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 4 | 0 | −2 | −4 | −5 | −5 | −5 | −4 | −5 | −4 | −5 | −6 | −8 | −11 | −12 | −13 | −13 | −14 | −12 |
| C | 4 | 7 | 5 | 1 | −1 | −3 | −4 | −4 | −4 | −4 | −4 | −5 | −6 | −9 | −11 | −12 | −13 | −13 | −13 | −12 |
| D | 0 | 5 | 7 | 5 | 2 | −1 | −2 | −3 | −3 | −4 | −4 | −5 | −7 | −9 | −11 | −11 | −12 | −13 | −13 | −13 |
| E | −2 | 1 | 5 | 6 | 5 | 2 | 0 | −1 | −2 | −3 | −4 | −5 | −7 | −9 | −11 | −12 | −13 | −13 | −14 | −14 |
| F | −4 | −1 | 2 | 5 | 6 | 5 | 2 | 1 | −1 | −3 | −4 | −5 | −7 | −10 | −12 | −13 | −14 | −14 | −15 | −14 |
| G | −5 | −3 | −1 | 2 | 5 | 6 | 5 | 2 | 0 | −2 | −4 | −5 | −7 | −10 | −12 | −13 | −14 | −14 | −15 | −14 |
| H | −5 | −4 | −2 | 0 | 2 | 5 | 6 | 5 | 2 | −1 | −3 | −5 | −7 | −10 | −12 | −14 | −15 | −14 | −14 | −14 |
| I | −5 | −4 | −3 | −1 | 1 | 2 | 5 | 6 | 4 | 1 | −2 | −4 | −6 | −10 | −12 | −13 | −15 | −15 | −15 | −13 |
| K | −4 | −4 | −3 | −2 | −1 | 0 | 2 | 4 | 6 | 4 | 1 | −2 | −5 | −9 | −11 | −13 | −14 | −15 | −14 | −13 |
| L | −5 | −4 | −4 | −3 | −3 | −2 | −1 | 1 | 4 | 7 | 5 | 0 | −5 | −8 | −10 | −12 | −13 | −13 | −13 | −12 |
| M | −4 | −4 | −4 | −4 | −4 | −4 | −3 | −2 | 1 | 5 | 7 | 4 | −3 | −7 | −10 | −11 | −11 | −12 | −12 | −11 |
| N | −5 | −5 | −5 | −5 | −5 | −5 | −5 | −4 | −2 | 0 | 4 | 8 | 3 | −5 | −8 | −10 | −11 | −11 | −11 | −10 |
| P | −6 | −6 | −7 | −7 | −7 | −7 | −7 | −6 | −5 | −5 | −3 | 3 | 8 | 3 | −5 | −8 | −9 | −10 | −10 | −9 |
| Q | −8 | −9 | −9 | −9 | −10 | −10 | −10 | −10 | −9 | −8 | −7 | −5 | 3 | 7 | 2 | −3 | −4 | −5 | −6 | −6 |
| R | −11 | −11 | −11 | −11 | −12 | −12 | −12 | −12 | −11 | −10 | −10 | −8 | −5 | 2 | 5 | 3 | 1 | 0 | −1 | −1 |
| S | −12 | −12 | −11 | −12 | −13 | −13 | −14 | −13 | −13 | −12 | −11 | −10 | −8 | −3 | 3 | 4 | 3 | 2 | 1 | 0 |
| T | −13 | −13 | −12 | −13 | −14 | −14 | −15 | −15 | −14 | −13 | −11 | −11 | −9 | −4 | 1 | 3 | 3 | 3 | 2 | 1 |
| V | −13 | −13 | −13 | −13 | −14 | −14 | −14 | −15 | −15 | −13 | −12 | −11 | −10 | −5 | 0 | 2 | 3 | 3 | 3 | 2 |
| W | −14 | −13 | −13 | −14 | −15 | −15 | −14 | −15 | −14 | −13 | −12 | −11 | −10 | −6 | −1 | 1 | 2 | 3 | 3 | 3 |
| Y | −12 | −12 | −13 | −14 | −14 | −14 | −14 | −13 | −13 | −12 | −11 | −10 | −9 | −6 | −1 | 0 | 1 | 2 | 3 | 4 |

Table F shows a matrix particularly suitable for a window size of five (6) and a cluster 80 (i.e., similarity of 80%.)

TABLE F

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 3 | −2 | −5 | −6 | −8 | −8 | −8 | −7 | −6 | −6 | −7 | −8 | −10 | −13 | −13 | −14 | −15 | −15 | −13 |
| C | 3 | 8 | 4 | 0 | −3 | −5 | −6 | −6 | −6 | −6 | −7 | −7 | −7 | −11 | −13 | −13 | −14 | −15 | −14 | −13 |
| D | −2 | 4 | 7 | 4 | 0 | −2 | −4 | −4 | −5 | −5 | −6 | −7 | −8 | −12 | −12 | −12 | −13 | −14 | −14 | −14 |
| E | −5 | 0 | 4 | 7 | 4 | 1 | −1 | −3 | −3 | −5 | −6 | −7 | −9 | −12 | −13 | −12 | −14 | −15 | −15 | −14 |
| F | −6 | −3 | 0 | 4 | 6 | 4 | 1 | −1 | −3 | −5 | −6 | −7 | −10 | −12 | −14 | −15 | −16 | −16 | −16 | −15 |
| G | −8 | −5 | −2 | 1 | 4 | 6 | 4 | 1 | −2 | −4 | −6 | −7 | −10 | −13 | −14 | −15 | −16 | −16 | −16 | −16 |
| H | −8 | −6 | −4 | −1 | 1 | 4 | 6 | 4 | 0 | −3 | −6 | −7 | −10 | −13 | −14 | −16 | −17 | −17 | −16 | −16 |
| I | −8 | −6 | −4 | −3 | −1 | 1 | 4 | 6 | 4 | −1 | −4 | −6 | −9 | −12 | −13 | −14 | −16 | −17 | −16 | −14 |
| K | −7 | −6 | −5 | −3 | −3 | −2 | 0 | 4 | 7 | 4 | −1 | −5 | −8 | −11 | −12 | −14 | −15 | −16 | −16 | −15 |
| L | −6 | −6 | −5 | −5 | −5 | −4 | −3 | −1 | 4 | 7 | 4 | −2 | −7 | −10 | −11 | −13 | −13 | −14 | −15 | −14 |
| M | −6 | −7 | −6 | −6 | −6 | −6 | −6 | −4 | −1 | 4 | 7 | 4 | −5 | −9 | −11 | −11 | −12 | −12 | −12 | −11 |
| N | −7 | −7 | −7 | −7 | −7 | −7 | −7 | −6 | −5 | −2 | 4 | 8 | 2 | −7 | −10 | −12 | −13 | −13 | −13 | −11 |
| P | −8 | −7 | −8 | −9 | −10 | −10 | −10 | −9 | −8 | −7 | −5 | 2 | 8 | 2 | −6 | −9 | −11 | −12 | −12 | −11 |
| Q | −10 | −11 | −12 | −12 | −12 | −13 | −13 | −12 | −11 | −10 | −9 | −7 | 2 | 8 | 2 | −4 | −6 | −7 | −8 | −8 |
| R | −13 | −13 | −12 | −13 | −14 | −14 | −14 | −13 | −12 | −11 | −11 | −10 | −6 | 2 | 6 | 4 | 1 | −1 | −2 | −2 |
| S | −13 | −13 | −12 | −12 | −15 | −15 | −16 | −14 | −14 | −13 | −11 | −12 | −9 | −4 | 4 | 5 | 4 | 2 | 1 | 0 |
| T | −14 | −14 | −13 | −14 | −16 | −16 | −17 | −16 | −15 | −13 | −12 | −13 | −11 | −6 | 1 | 4 | 4 | 4 | 2 | 1 |
| V | −15 | −15 | −14 | −15 | −16 | −16 | −17 | −17 | −16 | −14 | −12 | −13 | −12 | −7 | −1 | 2 | 4 | 4 | 4 | 2 |
| W | −15 | −14 | −14 | −15 | −16 | −16 | −16 | −16 | −16 | −15 | −12 | −13 | −12 | −8 | −2 | 1 | 2 | 4 | 4 | 4 |
| Y | −13 | −13 | −14 | −14 | −15 | −16 | −16 | −14 | −15 | −14 | −11 | −11 | −11 | −8 | −2 | 0 | 1 | 2 | 4 | 6 |

Table G shows a matrix particularly suitable for a window size of six (6) and a cluster 45 (i.e., similarity of 45%.)

TABLE G

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 7 | 4 | 1 | 0 | −1 | −1 | −2 | −1 | −1 | −1 | −1 | −2 | −3 | −5 | −6 | −9 | −10 | −11 | −10 | −10 |
| C | 4 | 5 | 4 | 2 | 0 | 0 | −1 | −1 | −1 | −1 | −2 | −2 | −4 | −5 | −6 | −9 | −10 | −10 | −10 | −10 |
| D | 1 | 4 | 5 | 4 | 2 | 1 | 0 | 0 | 0 | −1 | −1 | −2 | −4 | −5 | −6 | −10 | −10 | −10 | −11 | −11 |
| E | 0 | 2 | 4 | 4 | 4 | 2 | 1 | 0 | 0 | −1 | −2 | −3 | −4 | −6 | −7 | −9 | −9 | −10 | −11 | −11 |
| F | −1 | 0 | 2 | 4 | 4 | 4 | 2 | 1 | 0 | −1 | −2 | −3 | −4 | −6 | −7 | −10 | −11 | −12 | −12 | −12 |
| G | −1 | 0 | 1 | 2 | 4 | 4 | 4 | 2 | 1 | −1 | −2 | −3 | −4 | −6 | −7 | −10 | −10 | −12 | −11 | −11 |
| H | −2 | −1 | 0 | 1 | 2 | 4 | 4 | 3 | 2 | 0 | −1 | −3 | −4 | −5 | −7 | −10 | −11 | −11 | −11 | −11 |
| I | −1 | −1 | 0 | 0 | 1 | 2 | 3 | 4 | 3 | 2 | 0 | −2 | −4 | −4 | −6 | −10 | −10 | −11 | −11 | −11 |
| K | −1 | −1 | 0 | 0 | 0 | 1 | 2 | 3 | 5 | 4 | 1 | −1 | −3 | −4 | −6 | −8 | −9 | −10 | −10 | −10 |
| L | −1 | −1 | −1 | −1 | −1 | −1 | 0 | 2 | 4 | 5 | 4 | 1 | −2 | −3 | −5 | −8 | −8 | −9 | −9 | −9 |
| M | −1 | −2 | −1 | −2 | −2 | −2 | −1 | 0 | 1 | 4 | 6 | 4 | 0 | −2 | −4 | −7 | −8 | −8 | −9 | −8 |
| N | −2 | −2 | −2 | −3 | −3 | −3 | −3 | −2 | −1 | 1 | 4 | 6 | 4 | 0 | −3 | −6 | −7 | −7 | −7 | −8 |
| P | −3 | −4 | −4 | −4 | −4 | −4 | −4 | −4 | −3 | −2 | 0 | 4 | 7 | 4 | −1 | −5 | −5 | −6 | −6 | −6 |
| Q | −5 | −5 | −5 | −6 | −6 | −6 | −5 | −4 | −4 | −3 | −2 | 0 | 4 | 7 | 3 | −3 | −4 | −4 | −5 | −4 |
| R | −6 | −6 | −6 | −7 | −7 | −7 | −7 | −6 | −6 | −5 | −4 | −3 | −1 | 3 | 6 | 3 | 1 | 0 | 0 | 0 |
| S | −9 | −9 | −10 | −9 | −10 | −10 | −10 | −10 | −8 | −8 | −7 | −6 | −5 | −3 | 3 | 4 | 3 | 2 | 2 | 2 |
| T | −10 | −10 | −10 | −9 | −11 | −10 | −11 | −10 | −9 | −8 | −8 | −7 | −5 | −4 | 1 | 3 | 3 | 3 | 3 | 2 |
| V | −11 | −10 | −10 | −10 | −12 | −12 | −11 | −11 | −10 | −9 | −8 | −7 | −6 | −4 | 0 | 2 | 3 | 3 | 3 | 3 |
| W | −10 | −10 | −11 | −11 | −12 | −11 | −11 | −11 | −10 | −9 | −9 | −7 | −6 | −5 | 0 | 2 | 3 | 3 | 3 | 3 |
| Y | −10 | −10 | −11 | −11 | −12 | −11 | −11 | −11 | −10 | −9 | −8 | −8 | −6 | −4 | 0 | 2 | 2 | 3 | 3 | 4 |

Table H shows a matrix particularly suitable for a window size of six (6) and a cluster 62 (i.e., similarity of 62%.)

TABLE H

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 4 | 1 | −1 | −3 | −3 | −4 | −3 | −3 | −3 | −4 | −5 | −6 | −8 | −8 | −13 | −14 | −13 | −14 | −13 |
| C | 4 | 7 | 5 | 1 | −1 | −2 | −3 | −2 | −3 | −3 | −4 | −5 | −7 | −9 | −9 | −13 | −14 | −14 | −15 | −13 |
| D | 1 | 5 | 6 | 5 | 2 | 0 | −1 | −1 | −2 | −3 | −4 | −5 | −7 | −9 | −10 | −12 | −13 | −12 | −14 | −13 |
| E | −1 | 1 | 5 | 6 | 5 | 2 | 1 | 0 | −2 | −3 | −4 | −6 | −8 | −10 | −10 | −13 | −14 | −14 | −14 | −13 |
| F | −3 | −1 | 2 | 5 | 6 | 5 | 2 | 1 | −1 | −3 | −4 | −5 | −7 | −9 | −11 | −14 | −15 | −15 | −16 | −15 |
| G | −3 | −2 | 0 | 2 | 5 | 6 | 5 | 2 | 0 | −2 | −4 | −6 | −8 | −10 | −11 | −14 | −15 | −16 | −16 | −15 |
| H | −4 | −3 | −1 | 1 | 2 | 5 | 6 | 4 | 2 | −1 | −3 | −5 | −7 | −9 | −11 | −15 | −15 | −15 | −15 | −14 |
| I | −3 | −2 | −1 | 0 | 1 | 2 | 4 | 6 | 4 | 1 | −2 | −4 | −7 | −8 | −10 | −13 | −14 | −14 | −16 | −14 |
| K | −3 | −3 | −2 | −2 | −1 | 0 | 2 | 4 | 6 | 5 | 1 | −3 | −6 | −8 | −8 | −12 | −13 | −13 | −13 | −13 |
| L | −3 | −3 | −3 | −3 | −3 | −2 | −1 | 1 | 5 | 7 | 4 | 0 | −4 | −7 | −9 | −11 | −12 | −13 | −13 | −12 |
| M | −4 | −4 | −4 | −4 | −4 | −4 | −3 | −2 | 1 | 4 | 7 | 4 | −2 | −5 | −8 | −11 | −12 | −13 | −12 | −12 |
| N | −5 | −5 | −5 | −6 | −5 | −6 | −5 | −4 | −3 | 0 | 4 | 8 | 4 | −3 | −6 | −10 | −11 | −11 | −11 | −11 |
| P | −6 | −7 | −7 | −8 | −7 | −8 | −7 | −7 | −6 | −4 | −2 | 4 | 8 | 3 | −4 | −9 | −10 | −11 | −11 | −10 |
| Q | −8 | −9 | −9 | −10 | −9 | −10 | −9 | −8 | −8 | −7 | −5 | −3 | 3 | 8 | 2 | −6 | −8 | −8 | −8 | −8 |
| R | −8 | −9 | −10 | −10 | −11 | −11 | −11 | −10 | −8 | −9 | −8 | −6 | −4 | 2 | 7 | 2 | −1 | −2 | −2 | −2 |
| S | −13 | −13 | −12 | −13 | −14 | −14 | −15 | −13 | −12 | −11 | −11 | −10 | −9 | −6 | 2 | 4 | 3 | 2 | 1 | 1 |
| T | −14 | −14 | −13 | −14 | −15 | −15 | −15 | −14 | −13 | −12 | −12 | −11 | −10 | −8 | −1 | 3 | 3 | 3 | 2 | 2 |
| V | −13 | −14 | −12 | −14 | −15 | −16 | −15 | −14 | −13 | −13 | −13 | −11 | −11 | −8 | −2 | 2 | 3 | 3 | 3 | 2 |
| W | −14 | −15 | −14 | −14 | −16 | −16 | −15 | −16 | −13 | −13 | −12 | −11 | −11 | −8 | −2 | 1 | 2 | 3 | 3 | 3 |
| Y | −13 | −13 | −13 | −13 | −15 | −15 | −14 | −14 | −13 | −12 | −12 | −11 | −10 | −8 | −2 | 1 | 2 | 2 | 3 | 4 |

Table I shows a matrix particularly suitable for a window size of six (6) and a cluster 80 (i.e., similarity of 80%.)

TABLE I

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 4 | −1 | −3 | −5 | −6 | −7 | −6 | −5 | −5 | −6 | −7 | −9 | −11 | −10 | −15 | −16 | −16 | −17 | −15 |
| C | 4 | 7 | 4 | 0 | −3 | −4 | −5 | −5 | −5 | −6 | −7 | −8 | −9 | −11 | −12 | −14 | −16 | −16 | −17 | −15 |
| D | −1 | 4 | 7 | 4 | 0 | −2 | −3 | −4 | −4 | −5 | −7 | −8 | −9 | −12 | −13 | −14 | −15 | −14 | −16 | −14 |
| E | −3 | 0 | 4 | 7 | 4 | 1 | −1 | −2 | −4 | −5 | −7 | −8 | −10 | −11 | −12 | −14 | −15 | −15 | −16 | −15 |
| F | −5 | −3 | 0 | 4 | 6 | 4 | 1 | −1 | −3 | −5 | −7 | −8 | −10 | −11 | −12 | −15 | −16 | −17 | −17 | −16 |
| G | −6 | −4 | −2 | 1 | 4 | 6 | 4 | 1 | −2 | −5 | −7 | −8 | −11 | −13 | −14 | −15 | −17 | −17 | −17 | −17 |
| H | −7 | −5 | −3 | −1 | 1 | 4 | 6 | 4 | 0 | −3 | −6 | −8 | −10 | −13 | −14 | −16 | −17 | −17 | −17 | −16 |
| I | −6 | −5 | −4 | −2 | −1 | 1 | 4 | 7 | 4 | 0 | −4 | −7 | −10 | −12 | −13 | −15 | −16 | −16 | −16 | −15 |
| K | −5 | −5 | −4 | −4 | −3 | −2 | 0 | 4 | 7 | 4 | −2 | −6 | −8 | −11 | −11 | −15 | −16 | −16 | −15 | −15 |
| L | −5 | −6 | −5 | −5 | −5 | −5 | −3 | 0 | 4 | 8 | 4 | −3 | −7 | −9 | −10 | −13 | −14 | −15 | −15 | −13 |
| M | −6 | −7 | −7 | −7 | −7 | −7 | −6 | −4 | −2 | 4 | 8 | 3 | −5 | −8 | −10 | −13 | −15 | −15 | −15 | −15 |
| N | −7 | −8 | −8 | −8 | −8 | −8 | −8 | −7 | −6 | −3 | 3 | 8 | 3 | −6 | −9 | −12 | −13 | −14 | −14 | −14 |
| P | −9 | −9 | −9 | −10 | −10 | −11 | −10 | −10 | −8 | −7 | −5 | 3 | 8 | 2 | −7 | −11 | −13 | −13 | −14 | −13 |
| Q | −11 | −11 | −12 | −11 | −11 | −13 | −13 | −12 | −11 | −9 | −8 | −6 | 2 | 8 | 1 | −8 | −10 | −10 | −11 | −10 |
| R | −10 | −12 | −13 | −12 | −12 | −14 | −14 | −13 | −11 | −10 | −10 | −9 | −7 | 1 | 8 | 2 | −2 | −4 | −5 | −5 |
| S | −15 | −14 | −14 | −14 | −15 | −15 | −16 | −15 | −15 | −13 | −13 | −12 | −11 | −8 | 2 | 5 | 3 | 2 | 1 | 0 |
| T | −16 | −16 | −15 | −15 | −16 | −17 | −17 | −16 | −16 | −14 | −15 | −13 | −13 | −10 | −2 | 3 | 4 | 3 | 2 | 1 |
| V | −16 | −16 | −14 | −15 | −17 | −17 | −17 | −16 | −16 | −15 | −15 | −14 | −13 | −10 | −4 | 2 | 3 | 4 | 3 | 2 |
| W | −17 | −17 | −16 | −16 | −17 | −17 | −17 | −16 | −15 | −15 | −15 | −14 | −14 | −11 | −5 | 1 | 2 | 3 | 4 | 4 |
| Y | −15 | −15 | −14 | −15 | −16 | −17 | −16 | −15 | −15 | −13 | −15 | −14 | −13 | −10 | −5 | 0 | 1 | 2 | 4 | 5 |

Table J shows a matrix particularly suitable for a window size of ten (10) and a cluster 45 (i.e., similarity of 45%.)

TABLE J

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 6 | 3 | 1 | −1 | −1 | −1 | −1 | −2 | −2 | −3 | −5 | −6 | −7 | −8 | −8 | −9 | −12 | −14 | −15 | −13 |
| C | 3 | 4 | 3 | 1 | 1 | 0 | 0 | −1 | −1 | −3 | −4 | −5 | −6 | −7 | −10 | −10 | −12 | −13 | −14 | −15 |
| D | 1 | 3 | 4 | 3 | 2 | 1 | 0 | 0 | −1 | −3 | −4 | −5 | −6 | −9 | −10 | −11 | −12 | −12 | −13 | −16 |
| E | −1 | 1 | 3 | 3 | 3 | 2 | 1 | 0 | −1 | −3 | −4 | −6 | −7 | −8 | −9 | −10 | −11 | −12 | −12 | −13 |
| F | −1 | 1 | 2 | 3 | 3 | 3 | 1 | 0 | −1 | −2 | −4 | −5 | −7 | −8 | −9 | −10 | −13 | −12 | −14 | −13 |
| G | −1 | 0 | 1 | 2 | 3 | 3 | 2 | 1 | 0 | −2 | −4 | −5 | −6 | −7 | −9 | −9 | −10 | −12 | −12 | −12 |
| H | −1 | 0 | 0 | 1 | 1 | 2 | 3 | 2 | 1 | −1 | −2 | −4 | −6 | −6 | −8 | −8 | −9 | −13 | −13 | −14 |
| I | −2 | −1 | 0 | 0 | 0 | 1 | 2 | 4 | 3 | 1 | −1 | −3 | −4 | −5 | −7 | −8 | −10 | −10 | −12 | −12 |
| K | −2 | −1 | −1 | −1 | −1 | 0 | 1 | 3 | 4 | 3 | 1 | −1 | −3 | −4 | −5 | −6 | −8 | −9 | −10 | −10 |
| L | −3 | −3 | −3 | −3 | −2 | −2 | −1 | 1 | 3 | 5 | 4 | 2 | 0 | −2 | −4 | −5 | −6 | −7 | −8 | −8 |
| M | −5 | −4 | −4 | −4 | −4 | −4 | −2 | −1 | 1 | 4 | 5 | 4 | 2 | 0 | −2 | −4 | −6 | −6 | −6 | −7 |
| N | −6 | −5 | −5 | −6 | −5 | −5 | −4 | −3 | −1 | 2 | 4 | 5 | 4 | 2 | 0 | −2 | −4 | −6 | −5 | −6 |
| P | −7 | −6 | −6 | −7 | −7 | −6 | −6 | −4 | −3 | 0 | 2 | 4 | 6 | 4 | 2 | 0 | −3 | −5 | −4 | −5 |
| Q | −8 | −7 | −9 | −8 | −8 | −7 | −6 | −5 | −4 | −2 | 0 | 2 | 4 | 6 | 4 | 2 | −1 | −4 | −3 | −4 |
| R | −8 | −10 | −10 | −9 | −9 | −9 | −8 | −7 | −5 | −4 | −2 | 0 | 2 | 4 | 6 | 4 | 1 | −2 | −2 | −3 |
| S | −9 | −10 | −11 | −10 | −10 | −9 | −8 | −8 | −6 | −5 | −4 | −2 | 0 | 2 | 4 | 6 | 4 | 1 | 0 | 0 |
| T | −12 | −12 | −12 | −11 | −13 | −10 | −9 | −10 | −8 | −6 | −6 | −4 | −3 | −1 | 1 | 4 | 6 | 4 | 3 | 3 |
| V | −14 | −13 | −12 | −12 | −12 | −12 | −13 | −10 | −9 | −7 | −6 | −6 | −5 | −4 | −2 | 1 | 4 | 5 | 5 | 5 |
| W | −15 | −14 | −13 | −12 | −14 | −12 | −13 | −12 | −10 | −8 | −6 | −5 | −4 | −3 | −2 | 0 | 3 | 5 | 5 | 5 |
| Y | −13 | −15 | −16 | −13 | −13 | −12 | −14 | −12 | −10 | −8 | −7 | −6 | −5 | −4 | −3 | 0 | 3 | 5 | 5 | 6 |

Table K shows a matrix particularly suitable for a window size of ten (10) and a cluster 62 (i.e., similarity of 62%.)

TABLE K

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 7 | 3 | 0 | −2 | −3 | −3 | −3 | −3 | −4 | −5 | −6 | −8 | −9 | −9 | −10 | −12 | −15 | −18 | −19 | −17 |
| C | 3 | 5 | 3 | 1 | 0 | −1 | −1 | −2 | −3 | −4 | −6 | −8 | −9 | −10 | −12 | −13 | −16 | −17 | −17 | −19 |
| D | 0 | 3 | 5 | 3 | 1 | 0 | 0 | −1 | −3 | −4 | −6 | −7 | −10 | −11 | −13 | −14 | −15 | −17 | −17 | −19 |
| E | −2 | 1 | 3 | 5 | 3 | 2 | 0 | −1 | −2 | −4 | −6 | −8 | −9 | −11 | −12 | −13 | −14 | −14 | −15 | −16 |
| F | −3 | 0 | 1 | 3 | 5 | 3 | 1 | 0 | −2 | −4 | −6 | −8 | −9 | −11 | −11 | −13 | −16 | −15 | −17 | −17 |
| G | −3 | −1 | 0 | 2 | 3 | 5 | 3 | 1 | −1 | −3 | −6 | −8 | −9 | −10 | −11 | −12 | −14 | −16 | −15 | −15 |
| H | −3 | −1 | 0 | 0 | 1 | 3 | 5 | 3 | 1 | −2 | −4 | −6 | −8 | −9 | −10 | −12 | −12 | −15 | −16 | −17 |
| I | −3 | −2 | −1 | −1 | 0 | 1 | 3 | 5 | 3 | 0 | −2 | −5 | −7 | −8 | −10 | −11 | −12 | −13 | −14 | −14 |
| K | −4 | −3 | −3 | −2 | −2 | −1 | 1 | 3 | 5 | 4 | 0 | −2 | −5 | −6 | −8 | −9 | −11 | −12 | −13 | −13 |
| L | −5 | −4 | −4 | −4 | −4 | −3 | −2 | 0 | 4 | 6 | 4 | 1 | −2 | −4 | −6 | −8 | −9 | −10 | −11 | −11 |
| M | −6 | −6 | −6 | −6 | −6 | −6 | −4 | −2 | 0 | 4 | 7 | 4 | 1 | −2 | −5 | −7 | −9 | −9 | −10 | −10 |
| N | −8 | −8 | −7 | −8 | −8 | −8 | −6 | −5 | −2 | 1 | 4 | 7 | 5 | 1 | −2 | −5 | −7 | −9 | −9 | −9 |
| P | −9 | −9 | −10 | −9 | −9 | −9 | −8 | −7 | −5 | −2 | 1 | 5 | 7 | 4 | 0 | −3 | −6 | −8 | −8 | −8 |
| Q | −9 | −10 | −11 | −11 | −11 | −10 | −9 | −8 | −6 | −4 | −2 | 1 | 4 | 7 | 4 | 0 | −3 | −6 | −7 | −7 |
| R | −10 | −12 | −13 | −12 | −11 | −11 | −10 | −10 | −8 | −6 | −5 | −2 | 0 | 4 | 7 | 4 | −1 | −4 | −6 | −6 |
| S | −12 | −13 | −14 | −13 | −13 | −12 | −12 | −11 | −9 | −8 | −7 | −5 | −3 | 0 | 4 | 7 | 4 | −2 | −3 | −3 |
| T | −15 | −16 | −15 | −14 | −16 | −14 | −12 | −12 | −11 | −9 | −9 | −7 | −6 | −3 | −1 | 4 | 7 | 3 | 2 | 1 |
| V | −18 | −17 | −17 | −14 | −15 | −16 | −15 | −13 | −12 | −10 | −9 | −9 | −8 | −6 | −4 | −2 | 3 | 5 | 5 | 4 |
| W | −19 | −17 | −17 | −15 | −17 | −15 | −16 | −14 | −13 | −11 | −10 | −9 | −8 | −7 | −6 | −3 | 2 | 5 | 5 | 5 |
| Y | −17 | −19 | −19 | −16 | −17 | −15 | −17 | −14 | −13 | −11 | −10 | −9 | −8 | −7 | −6 | −3 | 1 | 4 | 5 | 6 |

Table L shows a matrix particularly suitable for a window size of ten (10) and a cluster 80 (i.e., similarity of 80%.)

TABLE L

| | A | C | D | E | F | G | H | I | K | L | M | N | P | Q | R | S | T | V | W | Y |
|---|---|---|---|---|---|---|---|---|---|---|---|---|---|---|---|---|---|---|---|---|
| A | 8 | 3 | −2 | −4 | −5 | −5 | −5 | −5 | −6 | −7 | −9 | −11 | −12 | −12 | −13 | −16 | −19 | −23 | −27 | −22 |
| C | 3 | 7 | 4 | 0 | −2 | −3 | −3 | −4 | −5 | −7 | −9 | −10 | −12 | −14 | −14 | −18 | −18 | −20 | −22 | −21 |
| D | −2 | 4 | 6 | 4 | 1 | −1 | −2 | −3 | −5 | −7 | −9 | −10 | −13 | −15 | −18 | −20 | −16 | −18 | −19 | −18 |
| E | −4 | 0 | 4 | 6 | 4 | 1 | −1 | −3 | −5 | −7 | −9 | −10 | −12 | −14 | −17 | −18 | −19 | −19 | −20 | −19 |
| F | −5 | −2 | 1 | 4 | 6 | 4 | 1 | −2 | −4 | −6 | −9 | −11 | −12 | −15 | −16 | −18 | −21 | −18 | −19 | −18 |
| G | −5 | −3 | −1 | 1 | 4 | 6 | 4 | 0 | −3 | −6 | −8 | −10 | −12 | −15 | −15 | −17 | −18 | −17 | −17 | −16 |
| H | −5 | −3 | −2 | −1 | 1 | 4 | 6 | 4 | −1 | −4 | −7 | −9 | −12 | −13 | −15 | −16 | −17 | −20 | −20 | −21 |
| I | −5 | −4 | −3 | −3 | −2 | 0 | 4 | 6 | 3 | −1 | −5 | −7 | −10 | −12 | −14 | −14 | −17 | −17 | −18 | −18 |
| K | −6 | −5 | −5 | −5 | −4 | −3 | −1 | 3 | 7 | 4 | −1 | −5 | −8 | −10 | −11 | −12 | −15 | −18 | −18 | −17 |
| L | −7 | −7 | −7 | −7 | −6 | −6 | −4 | −1 | 4 | 7 | 4 | −1 | −5 | −7 | −10 | −12 | −13 | −14 | −15 | −15 |
| M | −9 | −9 | −9 | −9 | −9 | −8 | −7 | −5 | −1 | 4 | 7 | 4 | −2 | −5 | −8 | −11 | −12 | −13 | −13 | −13 |
| N | −11 | −10 | −10 | −10 | −11 | −10 | −9 | −7 | −5 | −1 | 4 | 8 | 4 | −1 | −5 | −8 | −11 | −12 | −12 | −13 |
| P | −12 | −12 | −13 | −12 | −12 | −12 | −12 | −10 | −8 | −5 | −2 | 4 | 8 | 4 | −3 | −7 | −10 | −12 | −13 | −12 |
| Q | −12 | −14 | −15 | −14 | −15 | −15 | −13 | −12 | −10 | −7 | −5 | −1 | 4 | 8 | 4 | −4 | −6 | −10 | −11 | −11 |
| R | −13 | −14 | −18 | −17 | −16 | −15 | −15 | −14 | −11 | −10 | −8 | −5 | −3 | 4 | 8 | 3 | −4 | −9 | −10 | −10 |
| S | −16 | −18 | −20 | −18 | −18 | −17 | −16 | −14 | −12 | −12 | −11 | −8 | −7 | −4 | 3 | 8 | 3 | −5 | −7 | −7 |
| T | −19 | −18 | −16 | −19 | −21 | −18 | −17 | −17 | −15 | −13 | −12 | −11 | −10 | −6 | −4 | 3 | 7 | 2 | −1 | −2 |
| V | −23 | −20 | −18 | −19 | −18 | −17 | −20 | −17 | −18 | −14 | −13 | −12 | −12 | −10 | −9 | −5 | 2 | 6 | 4 | 3 |
| W | −27 | −22 | −19 | −20 | −19 | −17 | −20 | −18 | −18 | −15 | −13 | −12 | −13 | −11 | −10 | −7 | −1 | 4 | 5 | 5 |
| Y | −22 | −21 | −18 | −19 | −18 | −16 | −21 | −18 | −17 | −15 | −13 | −13 | −12 | −11 | −10 | −7 | −2 | 3 | 5 | 6 |

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other analysis computing systems not necessarily the exemplary protein analysis computing system generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links) whether wired, wireless or both.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 60/726,829, filed Oct. 14, 2005, are incorporated herein by reference, in their entirety. Aspects of the invention can be modified, if necessary, to employ systems, circuits and concepts of the various patents, applications and publications to provide yet further embodiments.

These and other changes can be made in light of the above-detailed description. In general, in the following claims, the terms used should not be construed to limit the invention to the specific embodiments disclosed in the specification and the claims, but should be construed to include all systems, methods and articles that facilitate analysis of multi-dimensional topographic information via one-dimensional sequence encoding. Accordingly, the invention is not limited by the disclosure, but instead its scope is to be determined entirely by the following claims.

We/I claim:

1. A method of mapping between multi-dimensional topological information and one-dimensional sequence representation, useful in analyzing structures, the method comprising:
for each of a number of substructures, determining a non-distance parameter indicative of a topology of the substructure; and
determining a sequence of character representations for each of at least two of the substructures, the respective character representation for each of the substructures based on the respective determined non-distance parameter indicative of the topology of the substructure.

2. The method of claim 1 wherein the multi-dimensional topology of the substructure is three-dimensional and wherein determining a non-distance parameter indicative of a topology of the substructure comprises determining a one-dimensional value indicative of the three-dimensional topology.

3. The method of claim 1 wherein the multi-dimensional topology of the substructure is three-dimensional and wherein determining a non-distance parameter indicative of a topology of the substructure comprises determining a writhing number indicative of the three-dimensional topology of the substructure.

4. The method of claim 1 wherein the substructure comprises at least four alpha carbons of a protein structure.

5. The method of claim 4 wherein determining a non-distance parameter indicative of a topology of the substructure comprises determining a writhing number indicative of a three-dimensional topology of the substructure comprised of the at least four alpha carbons.

6. The method of claim 5 wherein determining a writhing number indicative of a three-dimensional topology of the substructure comprises determining the writhing number of a polygonal curved surface representative of the topology of the substructure comprised of the at least four alpha carbons.

7. The method of claim 5 wherein determining a writhing number indicative of a three-dimensional topology of the substructure comprises determining the writhing number of a polygonal curved surface defined by at least four vectors, a first vector extending from a first one of the alpha carbons to a second one of the alpha carbons, a second vector extending from the first one of the alpha carbons to a third one of the alpha carbons, a third vector extending from a fourth one of the alpha carbons to the second one of the alpha carbons, and a fourth vector extending from the fourth one of the alpha carbons to the third one of the alpha carbons.

8. The method of claim 1 wherein the substructure comprises at least four repeating portions of a polymer structure.

9. The method of claim 1 wherein determining a sequence of character representations for each of at least two of the substructures comprises assigning a new character representation to the determined non-distance parameters indicative of the topologies of the substructures, the character representations forming a set of character representations.

10. The method of claim 1 wherein determining a sequence of character representations for each of at least two of the substructures comprises comparing the determined non-distance parameter to at least one of a number of non-distance parameters in a library of non-distance parameters, each of the non-distance parameters in the library having a previously assigned respective character representation.

11. The method of claim 10 wherein comparing the determined non-distance parameter to one of a number of non-distance parameters in a library of non-distance parameters comprises comparing a determined writhing number to at least some of at least twenty writhing numbers in the library of non-distance parameters.

12. The method of claim 1 wherein determining a sequence of character representations for each of at least two of the substructures comprises selecting the character representations from a set of character representations.

13. The method of claim 1 wherein determining a sequence of character representations for each of at least two of the substructures comprises selecting the character representations from a set of alphabetic character representations.

14. The method of claim 1, further comprising:
performing a sequence analysis on the determined sequence.

15. A computer-readable medium storing instructions for causing a computer to facilitate mapping between multi-dimensional topological information and one-dimensional sequence representation, by:
for each of a number of substructures, determining a non-distance parameter indicative of a topology of the substructure; and
determining a sequence of character representations for each of at least two of the substructures, the respective character representation for each of the substructures based on the respective determined non-distance parameter indicative of the topology of the substructure.

16. The computer-readable medium of claim 15 wherein the multi-dimensional topology of the substructure is three-dimensional and wherein determining a non-distance parameter indicative of a topology of the substructure comprises determining a writhing number indicative of the three-dimensional topology of the substructure.

17. The computer-readable medium of claim 16 wherein determining a writhing number indicative of a three-dimensional topology of the substructure comprises determining the writhing number of a polygonal curved surface representative of the topology of the substructure comprised of the at least four alpha carbons.

18. The computer-readable medium of claim 16 wherein determining a writhing number indicative of a three-dimensional topology of the substructure comprises determining the writhing number of a polygonal curved surface representative of the topology of the substructure comprised of the at least four repetitive portions of a polymer.

19. The computer-readable medium of claim 15 wherein determining a sequence of character representations for each of at least two of the substructures comprises assigning a new character representation to the determined non-distance parameters indicative of the topologies of the substructures, the character representations forming a set of character representations.

20. The computer-readable medium of claim 15 wherein determining a sequence of character representations for each of at least two of the substructures comprises comparing the determined non-distance parameter to at least one of a number of non-distance parameters in a library of non-distance parameters, each of the non-distance parameters in the library having a previously assigned respective character representation.

21. The computer-readable medium of claim 15 wherein the instructions cause the computer to facilitate mapping between multi-dimensional topological information and one-dimensional sequence representation, further by:
performing a sequence analysis on the determined sequence.

22. A method of forming a library of relationships useful in analyzing multi-dimensional topological structures composed of one or more segments using one-dimensional sequencing representations, the method comprising:
for each of a plurality of structures, determining a topological parameter of at least some of a number of local segments of the structure; and
for each of at least some of the determined topological parameters, determining a respective character representation based at least in part on the respective determined topological parameter.

23. The method of claim 22 wherein the structures are proteins and wherein determining a topological parameter of at least some of the local segment comprises determining a writhing number indicative of a three-dimensional topology of the local segment comprised of at least four alpha carbons.

24. The method of claim 23 wherein determining a writhing number indicative of a three-dimensional topology of the local segment comprises determining the writhing number of a polygonal curved surface representative of the topology of the local segment comprised of the at least four alpha carbons.

25. The method of claim 23 wherein determining a writhing number indicative of a three-dimensional topology of the local segment comprises determining the writhing number of a polygonal curved surface defined by at last four vectors, a first vector extending from a first alpha carbon to a second alpha carbon, a second vector extending from the first alpha carbon to a third alpha carbon, a third vector extending from a fourth alpha carbon to the second alpha carbon, and a fourth vector extending from the fourth alpha carbon to the third alpha carbon.

26. The method of claim 22 wherein determining a respective character representation based at least in part on the respective determined topological parameter comprises binning the determined topological parameters and assigning a character representation as a result of the binning.

27. The method of claim 26 wherein binning the determined topological parameters comprises grouping the determined topological parameters into a plurality of groups, each group having a range of writhing values, where the ranges of the groups are not all equal to one another.

28. The method of claim 27 wherein binning the determined topological parameters further comprises determining the ranges of the group based at least in part of a frequency of occurrence of the respective determined topological parameters over the number of structures.

29. The method of claim 27 wherein binning the determined topological parameters further comprises determining the ranges of the group such that each group includes an approximately same number of occurrences of the respective determined topological parameters over the number of structures.

30. The method of claim 22, further comprising:
determining at least one substitution matrix for scoring alignments.

31. The method of claim 22 wherein the structures are proteins, and further comprising:
for each of the structures, selecting a number of local segments of the structure for analysis.

32. The method of claim 31 wherein selecting a number of local segments for analysis comprises selecting local segments comprising at least four distinct alpha carbons.

33. The method of claim 31 wherein selecting a number of local segments for analysis comprises selecting a plurality of local segments, each of the local segments comprising at least four distinct alpha carbons including a number of the alpha carbons from at least one immediately adjacent local segment.

34. The method of claim 31 wherein selecting a number of local segments for analysis comprises selecting a plurality of local segments, each of the local segments comprising at least four distinct alpha carbons including one of the alpha carbons from at least one immediately adjacent local segment.

35. The method of claim 22 wherein the structures are polymers, and further comprising:
for each of the structures, selecting a number of local segments of the structure for analysis.

36. A computer-readable medium storing instructions for causing a computer to facilitate forming a library of relationships useful in analyzing multi-dimensional topological structures composed of one or more segments using one-dimensional sequencing representations, by:
for each of a plurality of structures, determining a topological parameter of at least some of a number of local segments of the structure; and
for each of at least some of the determined topological parameters, determining a respective character representation based at least in part on the respective determined topological parameter.

37. The computer-readable medium of claim 36 wherein the structures are proteins and wherein determining a topological parameter of at least some of the local segment comprises determining a writhing number indicative of a three-dimensional topology of the local segment comprised of at least four alpha carbons.

38. The computer-readable medium of claim 37 wherein determining a writhing number indicative of a three-dimensional topology of the local segment comprises determining the writhing number of a polygonal curved surface representative of the topology of the local segment comprised of the at least four alpha carbons.

39. The computer-readable medium of claim 36 wherein determining a respective character representation based at least in part on the respective determined topological parameter comprises binning the determined topological parameters and assigning a character representation as a result of the binning.

40. The computer-readable medium of claim 39 wherein binning the determined topological parameters comprises grouping the determined topological parameters into a plurality of groups, each group having a range of writhing values, where the ranges of the groups are not all equal to one another.

41. The computer-readable medium of claim 40 wherein binning the determined topological parameters further comprises determining the ranges of the group such that each group includes an approximately same number of occurrences of the respective determined topological parameters over the number of structures.

42. The computer-readable medium of claim 36 wherein the instructions cause the computer to facilitate forming a library of relationships useful in analyzing multi-dimensional topological structures composed of one or more segments using one-dimensional sequencing representations, further by:
selecting a plurality of local segments for analysis, each of the local segments comprising at least four distinct alpha carbons including a number of the alpha carbons from at least one immediately adjacent local segment.

43. The computer-readable medium of claim 36 wherein the structures are polymers and wherein determining a topological parameter of at least some of the local segments comprises determining a writhing number indicative of a three-dimensional topology of the local segment comprised of at least four repetitive portions of the polymer.

44. A method of analyzing repetitive structures, the method comprising:
for each of a number of local segments of a repetitive structure, determining a topological parameter indicative of at least one non-distance multi-dimensional characteristic of the local segment;
for each of at least some of the determined topological parameters, determining a respective character representation based at least in part on the respective determined topological parameter; and
forming an ordered sequence from the determined character representations.

45. The method of claim 44 wherein the repetitive structure is a protein and determining a topological parameter indicative of at least one non-distance multi-dimensional characteristic of the local segment comprises determining a writhing number indicative of a three-dimensional topology of the local segment comprised of at least four alpha carbons.

46. The method of claim 45 wherein determining a writhing number indicative of a three-dimensional topology of the local segment comprises determining the writhing number of a polygonal curved surface representative of the topology of the local segment comprised of the at least four alpha carbons.

47. The method of claim 44, further comprising:
performing a sequence analysis on the resulting ordered sequence of determined character representations.

48. The method of claim 47 wherein performing a sequence analysis on the resulting ordered sequence of determined character representations comprises determining a level of similarity between the repetitive structure and another repetitive structure.

49. The method of claim 47 wherein performing a sequence analysis on the resulting ordered sequence of determined character representations comprises determining which portions of the repetitive structure are similar to portions of a number of other repetitive structures.

50. The method of claim 47 wherein performing a sequence analysis on the resulting ordered sequence of determined character representations comprises searching a database of repetitive structures to find other repetitive structures similar to the repetitive structure.

51. The method of claim 47, further comprising:
providing a result of the sequence analysis.

52. The method of claim 44, further comprising:
receiving a set of three-dimensional repetitive structure data from which the topological parameters are to be determined.

53. The method of claim 44 wherein the repetitive structure is a polymer and determining a topological parameter indicative of at least one non-distance multi-dimensional characteristic of the local segment comprises determining a writhing number indicative of a three-dimensional topology of the local segment of the polymer.

54. A computer-readable medium storing instructions for causing a computer to facilitate analysis of repetitive structures, by:
for each of a number of local segments of a repetitive structure, determining a topological parameter indicative of at least one non-distance multi-dimensional characteristic of the local segment;
for each of at least some of the determined topological parameters, determining a respective character representation based at least in part on the respective determined topological parameter; and
forming an ordered sequence from the determined character representations.

55. The computer-readable medium of claim 54 wherein the repetitive structure is a protein and wherein determining a topological parameter indicative of at least one non-distance multi-dimensional characteristic of the local segment comprises determining a writhing number indicative of a three-dimensional topology of the local segment comprised of at least four alpha carbons.

56. The computer-readable medium of claim 54 wherein the repetitive structure is a polymer and wherein determining a topological parameter indicative of at least one non-distance multi-dimensional characteristic of the local segment comprises determining a writhing number indicative of a three-dimensional topology of the local segment comprised of at least four repeating portions of the polymer.

57. The computer-readable medium of claim 54 wherein the instructions cause the computer to facilitate analysis of repetitive structures, further by:
performing a sequence analysis on the resulting ordered sequence of determined character representations.

58. The computer-readable medium of claim 57 wherein performing a sequence analysis on the resulting ordered sequence of determined character representations comprises at least one of: determining a level of similarity between the repetitive structure and another repetitive structure; determining which portions of the repetitive structure are similar to portions of a number of other repetitive structures, or searching a database of repetitive structures to find other repetitive structures similar to the repetitive structure.
